(19) United States
(12) Patent Application Publication
(10) Pub. No.: US 2021/0209443 A1
(43) Pub. Date: Jul. 8, 2021

(54) Distributed Processing System and Distributed Processing Method

(71) Applicant: Nippon Telegraph and Telephone Corporation, Tokyo (JP)

(72) Inventors: Kenji Kawai, Tokyo (JP); Junichi Kato, Tokyo (JP); Huycu Ngo, Tokyo (JP); Yuki Arikawa, Tokyo (JP); Tsuyoshi Ito, Tokyo (JP); Takeshi Sakamoto, Tokyo (JP)

(21) Appl. No.: 16/973,717

(22) PCT Filed: May 5, 2019
(86) PCT No.: PCT/JP2019/019895

§ 371 Date: Dec. 9, 2020

(30) Foreign Application Priority Data
Jun. 11, 2018 (JP) 2018-110926

(51) Int. Cl. G06N 3/04; G06N 3/08

(52) U.S. Cl. CPC G06N 3/04; G06N 3/08

(57) ABSTRACT

A first distributed processing node sets, as intermediate aggregated data, distributed data generated by the own node and transmits this data to the distributed processing node having the next number designated in advance. The intermediate distributed processing node excluding the first and last distributed processing nodes calculates, for each of weights corresponding thereto, a sum of the received intermediate aggregated data and distributed data generated by the own node, generates intermediate aggregated data after update, and transmits this data to the distributed processing node having the next number designated in advance. The last distributed processing node calculates, for each of the weights corresponding thereto, a sum of the received intermediate aggregated data and distributed data generated by the own node, generates aggregated data, and transmits this data to the first and intermediate distributed processing nodes. The distributed processing nodes update the weights of a neural network based on this data.

This patent application is a national phase filing under section 371 of PCT/JP2019/019895, filed May 20, 2019, which claims the priority of Japanese patent application number 2018-110926, filed Jun. 11, 2018, each of which is incorporated herein by reference in its entirety.

### TECHNICAL FIELD

The present invention relates to a distributed processing system including a plurality of distributed processing nodes and, more particularly, to a distributed processing system and a distributed processing method for aggregating numerical value data from the distributed processing nodes to generate aggregated data and distributing the aggregated data to the distributed processing nodes.

### BACKGROUND

In deep learning, concerning a learning target including multilayer neuron models, inference accuracy is improved by updating weights (coefficients multiplied with values output by neuron models at preceding stages) of neuron models based on input sample data.

Usually, a minibatch method is used as a method of improving inference accuracy. In the minibatch method, gradient calculation processing for calculating gradients for the weights for each of the sample data, aggregation processing for aggregating the gradients concerning a plurality of different sample data (totaling, for each of the weights, the gradients obtained for each of the sample data), and weight update processing for updating the weights based on the aggregated gradients are repeated.

These kinds of processing, in particular, the gradient calculation processing requires a large number of times of calculations. However, there is a problem that, when the number of weights and the number of input sample data increase in order to improve the inference accuracy, a time required for the deep learning increases.

In order to accelerate the gradient calculation processing, a method of distributed processing is used. Specifically, a plurality of distributed processing nodes are provided and the nodes respectively perform the gradient calculation processing concerning different sample data. Consequently, it is possible to increase, in proportion to the number of nodes, the number of sample data that can be processed in a unit time. Therefore, the gradient calculation processing can be accelerated (see Non-Patent Literature 1).

In the distributed processing of the deep learning, in order to perform the aggregation processing, between gradient calculation processing in which the distributed processing nodes calculate gradients for weights for each of the sample data and intra-node aggregation processing in which the distributed processing nodes total, for each of the weights, the gradients obtained for each of the sample data and weight update processing in which the distributed processing nodes update the weights based on the aggregated gradients, communication (aggregated communication) for transfer to a node that performs aggregation processing of transferring data (distributed data) obtained for each of the distributed processing node, processing (inter-node aggregation processing) for performing aggregation based on the data obtained by the aggregated communication, and communication (distributed communication) for distributing, to the distributed processing nodes, the aggregated data (aggregated data) acquired from the distributed processing nodes are necessary.

FIG. 22 is a block diagram showing a configuration example of a conventional distributed processing system for deep learning. A sequence of distributed processing of deep learning according to related art is shown in FIG. 23. Distributed processing nodes 100[n] (n=1, . . . , and N) perform sample data input, gradient calculation processing, and intra-node aggregation processing in a period of I and transmit distributed data to an aggregation processing node 101. In a period of II, transmission from such nodes is performed. However, the nodes do not always simultaneously transmit the distributed data.

In a period of III, the aggregation processing node 101 performs all-node aggregation processing for totaling, for each of the weights, the gradients obtained from the nodes. In a period of IV, the aggregation processing node 101 transmits aggregated data to the distributed processing nodes 100[n]. In a period of V, the distributed processing nodes 100[n] perform weight update processing.

The distributed processing is performed in this way, whereby processing times for the aggregated communication (II), the all-node aggregation processing (III), and the distributed communication (IV) are added to the deep learning.

Such processing times are unnecessary in a system that implements the deep learning in a single node. When the distributed processing of the deep learning is performed, the processing times cause a decrease in processing speed.

In recent years, the deep learning has been applied to more complicated problems. A total number of weights tend to increase. Accordingly, data amounts of distributed data and aggregated data increase and an aggregated communication time and a distributed communication time increase.

In this way, the distributed system of the deep learning has a problem that, because of the increase in the aggregated communication time and the distributed communication time, the effect of the acceleration of the deep learning is deteriorated by increasing the number of distributed processing nodes. FIG. 24 shows a relation between the number of distributed processing nodes and processing performance of the deep learning in the conventional distributed processing system. The reference numeral 200 indicates an ideal relation (performance∝the number of nodes) between the number of distributed processing nodes and the processing performance. The reference numeral 201 indicates an actual relation between the number of distributed processing nodes and the processing performance. A total amount of distributed data, which is an input of inter-node aggregation processing, increases in proportion to the number of distributed processing nodes but actual processing performance is not improved in proportion to the number of distributed processing nodes. This is because since communication speed of an aggregation processing node is limited to be equal to or lower than physical speed of a communication port of the node, a time required for aggregated communication increases.

### CITATION LIST

### Non-Patent Literature

Non-Patent Literature 1: Takuya Akiba, “Distributed deep learning package ChainerMN release”, Preferred Infrastructure, 2017, Internet <https://research.preferred.jp/2017/05/chainermn-beta-release/>

### SUMMARY

### Technical Problem

Embodiments of the present invention have been devised considering the circumstances described above and an object of embodiments of the present invention is to provide, in a distributed processing system including a plurality of distributed processing nodes, a distributed processing system and a distributed processing method that can perform effective distributed processing when being applied to deep learning.

### Means for Solving the Problem

A distributed processing system (a first embodiment) of the present invention includes N (N is an integer equal to or larger than 2) distributed processing nodes connected to one another via a network. The distributed processing nodes generate distributed data for each of M (M is an integer equal to or larger than 2) weights w[m] (m=1, . . . , and M) of a learning target neural network. Among the N distributed processing nodes, a predetermined first distributed processing node sets, as first aggregated data, distributed data generated by the own node, packetizes the first aggregated data in order of numbers m of the weights w[m], and transmits the first aggregated data to the distributed processing node having a next number designated in advance. Among the N distributed processing nodes, an intermediate distributed processing node excluding the first distributed processing node and a last distributed processing node calculates, for each of the weights w[m] corresponding thereto, a sum of the received first aggregated data and distributed data generated by the own node, generates first aggregated data after update, packetizes the first aggregated data in the order of the numbers m, and transmits the first aggregated data to the distributed processing node having a next number designated in advance. Among the N distributed processing nodes, a predetermined last distributed processing node calculates, for each of the weights w[m] corresponding thereto, a sum of the received first aggregated data and distributed data generated by the own node, generates second aggregated data, packetizes the second aggregated data in the order of the numbers m, and transmits the second aggregated data to the first and intermediate distributed processing nodes. The distributed processing nodes update the weights w[m] of the neural network based on the second aggregated data.

In a configuration example (the first embodiment) of the distributed processing system of an embodiment of the present invention, each of the distributed processing nodes includes: an aggregated-data transmission unit that, when the own node is the first distributed processing node, packetizes the first aggregated data in the order of the numbers m and transmits the first aggregated data to the distributed processing node having a next number designated in advance, when the own node is the intermediate distributed processing node, packetizes the first aggregated data after the update in the order of the numbers m and transmits the first aggregated data after the update to the distributed processing node having a next number designated in advance, and, when the own node is the last distributed processing node, packetizes the second aggregated data in the order of the numbers m and transmits the second aggregated data to the first and intermediate distributed processing nodes; an aggregated-data generation unit that, when the own node is the intermediate distributed processing node, generates the first aggregated data after the update and, when the own node is the last distributed processing node, generates the second aggregated data; a reception unit that, when the own node is the first or intermediate distributed processing node, receives the first aggregated data and the second aggregated data and, when the own node is the last distributed processing node, receives the first aggregated data; and a weight-update processing unit that updates the weights w[m] of the neural network based on the second aggregated data.

A distributed processing system (a second embodiment) of the present invention includes: K (K is an integer equal to or larger than 3) ring nodes disposed in a ring shape and connected to adjacent nodes of one another via a communication path; and a distributed-processing control unit that designates each of the K ring nodes as a distributed processing node or a relay node. Among the K ring nodes, N (N is an integer equal to or larger than 2 and equal to or smaller than K) ring nodes functioning as the distributed processing node generate distributed data for each of M (M is an integer equal to or larger than 2) weights w[m] (m=1, . . . , and M) of a learning target neural network. The ring node functioning as a first distributed processing node designated in advance among the N distributed processing nodes sets, as first aggregated data, distributed data generated by the own node, packetizes the first aggregated data in order of numbers m of the weights w[m], and transmits the first aggregated data to the distributed processing node having a next number designated in advance. The ring node functioning as an intermediate distributed processing node excluding the first distributed processing node and a last distributed processing node among the N distributed processing nodes calculates, for each of the weights w[m] corresponding thereto, a sum of the received first aggregated data and distributed data generated by the own node, generates first aggregated data after update, packetizes the first aggregated data in the order of the numbers m, and transmits the first aggregated data to the distributed processing node having a next number designated in advance. The ring node functioning as the last distributed processing node designated in advance among the N distributed processing nodes calculates, for each of the weights w[m] corresponding thereto, a sum of the received first aggregated data and distributed data generated by the own node, generates second aggregated data, packetizes the second aggregated data in the order of the numbers m, and transmits the second aggregated data to the distributed processing node having a preceding number designated in advance. The ring node functioning as the intermediate distributed processing node among the N distributed processing nodes packetizes the received second aggregated data in the order of the numbers m and transmits the second aggregated data to the distributed processing node having a preceding number designated in advance. Among the K ring nodes, the ring nodes functioning as the relay node transmit the received first aggregated data or second aggregated data to the distributed processing node at a transfer destination. The distributed processing nodes update the weights w[m] of the neural network based on the second aggregated data.

In a configuration example (the second embodiment) of the distributed processing system of an embodiment of the present invention, each of the ring nodes includes: an aggregated-data transmission unit that, when the own node functions as the first distributed processing node, packetizes the first aggregated data in the order of the numbers m and transmits the first aggregated data to the distributed processing node having a next number designated in advance, when the own node functions as the intermediate distributed processing node, packetizes the first aggregated data after the update in the order of the numbers m and transmits the first aggregated data after the update to the distributed processing node having a next number designated in advance, when the own node functions as the last distributed processing node, packetizes the second aggregated data in the order of the numbers m and transmits the second aggregated data to the distributed processing node having a preceding number designated in advance, and, when the own node functions as the relay node, transmits the received first aggregated data or second aggregated data to the distributed processing node at the transfer destination; an aggregated-data generation unit that, when the own node functions as the intermediate distributed processing node, generates the first aggregated data after the update and, when the own node functions as the last distributed processing node, generates the second aggregated data; a reception unit that, when the own node functions as the first or intermediate distributed processing node, receives the first aggregated data and the second aggregated data and, when the own node functions as the last distributed processing node, receives the first aggregated data; and a weight-update processing unit that updates the weights w[m] of the neural network based on the second aggregated data when the own node functions as the distributed processing node.

In a configuration example (a third embodiment) of the distributed processing system of an embodiment of the present invention, the distributed-processing control unit includes: a function designation unit that designates each of the K ring nodes as the distributed processing node or the relay node; and a function-designation changing unit that, when a failure to transmit the first aggregated data or the second aggregated data to the distributed processing node at the transfer designation occurs, changes a function designation of the ring nodes to avoid the failure.

In a configuration example (a fourth embodiment) of the distributed processing system of an embodiment of the present invention, the distributed-processing control unit designates each of the ring nodes designated as the distributed processing node to belong to any one group among a plurality of different groups. The ring node functioning as a first distributed processing node designated in advance among the N distributed processing nodes sets, as first aggregated data, distributed data generated by the own node, packetizes the first aggregated data in order of the numbers m of the weights w[m], and transmits the first aggregated data to the distributed processing node having a next number designated in advance belonging to a same group. The ring node functioning as an intermediate distributed processing node excluding the first distributed processing node and a last distributed processing node among the N distributed processing nodes calculates, for each of the weights w[m] corresponding thereto, a sum of the first aggregated data transmitted from the distributed processing node of the same group and distributed data generated by the own node, generates first aggregated data after update, packetizes the first aggregated data in the order of the numbers m, and transmits the first aggregated data to the distributed processing node having a next number designated in advance belonging to the same group. The ring node functioning as a predetermined last distributed processing node among the N distributed processing nodes calculates, for each of the weights w[m] corresponding thereto, a sum of the first aggregated data transmitted from the distributed processing node of the same group and distributed data generated by the own node, generates second aggregated data, packetizes the second aggregated data in the order of the numbers m, and transmits the second aggregated data to the distributed processing node having a preceding number designated in advance belonging to the same group. The ring node functioning as the intermediate distributed processing node among the N distributed processing nodes packetizes the second aggregated data transmitted from the distributed processing node of the same group in the order of the numbers m, and transmits the second aggregated data to the distributed processing node having a preceding number designated in advance belonging to the same group. The distributed processing nodes update the weights w[m] of the neural network based on the second aggregated data generated and transmitted in the distributed processing node of the same group.

A distributed processing method (a first embodiment) of the present invention includes: a first step in which each of N (N is an integer equal to or larger than 2) distributed processing nodes connected to one another via a network generates distributed data for each of M (M is an integer equal to or larger than 2) weights w[m] (m=1, . . . , and M) of a learning target neural network; a second step in which, among the N distributed processing nodes, a predetermined first distributed processing node sets, as first aggregated data, distributed data generated by the own node, packetizes the first aggregated data in order of numbers m of the weights w[m], and transmits the first aggregated data to the distributed processing node having a next number designated in advance; a third step in which, among the N distributed processing nodes, an intermediate distributed processing node excluding the first distributed processing node and a last distributed processing node calculates, for each of the weights w[m] corresponding thereto, a sum of the received first aggregated data and distributed data generated by the own node, generates first aggregated data after update, packetizes the first aggregated data in the order of the numbers m, and transmits the first aggregated data to the distributed processing node having a next number designated in advance; a fourth step in which, among the N distributed processing nodes, a predetermined last distributed processing node calculates, for each of the weights w[m] corresponding thereto, a sum of the received first aggregated data and distributed data generated by the own node, generates second aggregated data, packetizes the second aggregated data in the order of the numbers m, and transmits the second aggregated data to the first and intermediate distributed processing nodes; and a fifth step in which the distributed processing nodes update the weights w[m] of the neural network based on the second aggregated data.

A distributed processing method (a second embodiment) of the present invention includes: a first step in which, among K (K is an integer equal to or larger than 3) ring nodes disposed in a ring shape and connected to adjacent nodes of one another via a communication path, N (N is an integer equal to or larger than 2 and equal to or smaller than K) ring nodes functioning as distributed processing nodes generate distributed data for each of M (M is an integer equal to or larger than 2) weights w[m] (m=1, . . . , and M) of a learning target neural network; a second step in which the ring node functioning as a first distributed processing node designated in advance among the N distributed processing nodes sets, as first aggregated data, distributed data generated by the own node, packetizes the first aggregated data in order of numbers m of the weights w[m], and transmits the first aggregated data to the distributed processing node having a next number designated in advance; a third step in which the ring node functioning as an intermediate distributed processing node excluding the first distributed processing node and a last distributed processing node among the N distributed processing nodes calculates, for each of the weights w[m] corresponding thereto, a sum of the received first aggregated data and distributed data generated by the own node, generates first aggregated data after update, packetizes the first aggregated data in the order of the numbers m, and transmits the first aggregated data to the distributed processing node having a next number designated in advance; a fourth step in which the ring node functioning as the last distributed processing node designated in advance among the N distributed processing nodes calculates, for each of the weights w[m] corresponding thereto, a sum of the received first aggregated data and distributed data generated by the own node, generates second aggregated data, packetizes the second aggregated data in the order of the numbers m, and transmits the second aggregated data to the distributed processing node having a preceding number designated in advance; a fifth step in which the ring node functioning as the intermediate distributed processing node among the N distributed processing nodes packetizes the received second aggregated data in the order of the numbers m and transmits the second aggregated data to the distributed processing node having a preceding number designated in advance; a sixth step in which, among the K ring nodes, the ring nodes functioning as the relay node transmit, when receiving the first aggregated data or the second aggregated data, the received first aggregated data or second aggregated data to the distributed processing node at a transfer destination; and a seventh step in which the distributed processing nodes update the weights w[m] of the neural network based on the second aggregated data.

### Effects of Embodiments of the Invention

According to embodiments of the present invention, it is possible to substantially simultaneously perform aggregated communication processing, inter-node aggregation processing, and distributed communication processing in parallel, perform effective distributed processing, and improve learning efficiency of a neural network. In embodiments of the present invention, it is possible to perform distributed processing of deep learning without providing an aggregation processing node. The speed of the distributed processing is not limited by communication speed of the aggregation processing node.

### BRIEF DESCRIPTION OF THE DRAWINGS

FIG. 1 is a block diagram showing a configuration example of a distributed processing system for deep learning according to a first embodiment of the present invention.

FIG. 2 is a block diagram showing a configuration example of a distributed processing node of the distributed processing system for deep learning according to the first embodiment of the present invention.

FIG. 3 is a flowchart for explaining sample data input processing, gradient calculation processing, and intra-node aggregation processing of the distributed processing node according to the first embodiment of the present invention.

FIG. 4 is a flowchart for explaining aggregated communication processing, inter-node aggregation processing, and weight update processing of the distributed processing node according to the first embodiment of the present invention.

FIG. 5 is a diagram showing a sequence of processing of distributed processing nodes according to the first embodiment of the present invention.

FIG. 6 is a diagram showing the sequence of the processing of the distributed processing nodes according to the first embodiment of the present invention.

FIG. 7 is a block diagram showing a configuration example of a distributed processing system for deep learning according to a second embodiment of the present invention.

FIG. 8 is a diagram showing an example of a state in which a ring node is designated as a distributed processing node or a relay node in the second embodiment of the present invention.

FIG. 9 is a block diagram showing a configuration example of the distributed processing system for deep learning according to the second embodiment of the present invention.

FIG. 10 is a block diagram showing a configuration example of a distributed processing node of the distributed processing system for deep learning according to the second embodiment of the present invention.

FIG. 11 is a diagram for explaining the operation of the distributed processing system for deep learning according to the second embodiment of the present invention.

FIG. 12 is a flowchart for explaining aggregated communication processing, inter-node aggregation processing, and weight update processing of the distributed processing node according to the second embodiment of the present invention.

FIG. 13 is a diagram showing a sequence of processing of distributed processing nodes according to the second embodiment of the present invention.

FIG. 14 is a diagram showing the sequence of the processing of the distributed processing nodes according to the second embodiment of the present invention.

FIG. 15 is a block diagram showing a configuration example of a distributed processing node of a distributed processing system for deep learning according to a third embodiment of the present invention.

FIG. 16 is a block diagram showing a configuration example of a distributed-processing control unit of the distributed processing system for deep learning according to the third embodiment of the present invention.

FIG. 17 is a diagram showing a state in which ring nodes are designated as a distributed processing node or a relay node in the third embodiment of the present invention.

FIG. 18 is a diagram showing a state in which the ring nodes are designated as the distributed processing node or the relay node in the third embodiment of the present invention.

FIG. 19 is a diagram showing a state in which ring nodes are designated as a distributed processing node or a relay node in a fourth embodiment of the present invention.

FIG. 20 is a block diagram showing a configuration example of a distributed processing node of a distributed processing system for deep learning according to the fourth embodiment of the present invention.

FIG. 21 is a block diagram showing a configuration example of a distributed-processing control unit of the distributed processing system for deep learning according to the fourth embodiment of the present invention.

FIG. 22 is a block diagram showing a configuration example of a conventional distributed processing system for deep learning.

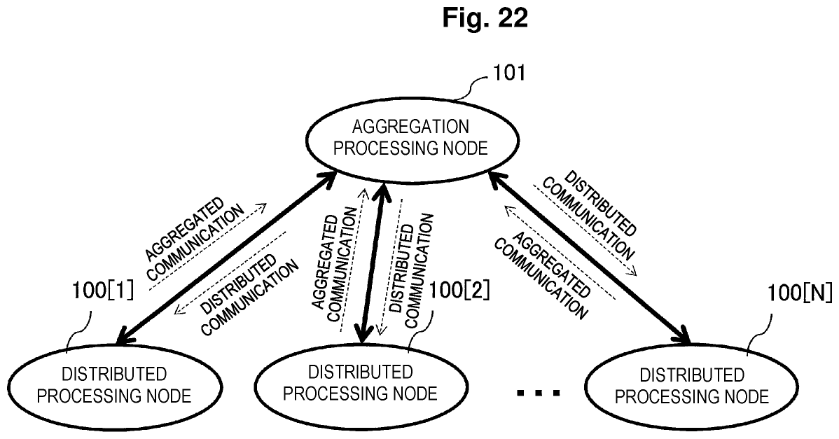

FIG. 23 is a diagram showing a sequence of distributed processing of the conventional deep learning.

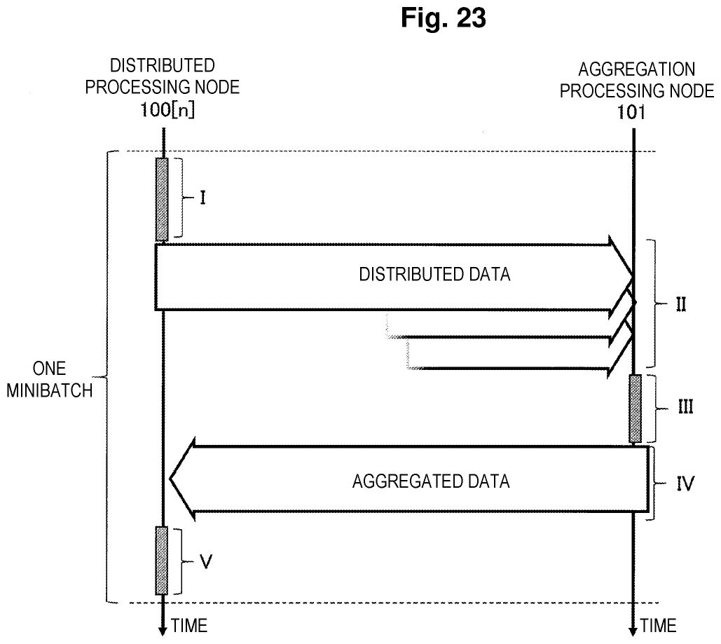

FIG. 24 is a diagram showing a relation between the number of distributed processing nodes and processing performance of deep learning in the conventional distributed processing system.

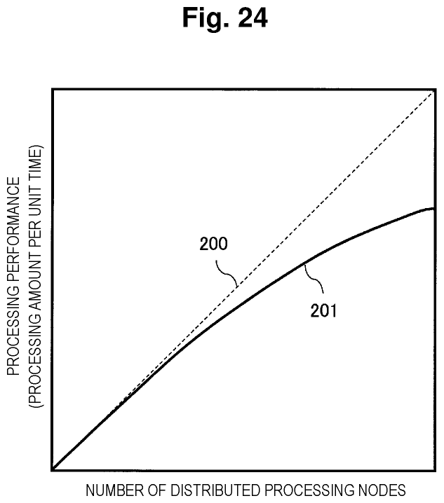

### DETAILED DESCRIPTION OF ILLUSTRATIVE EMBODIMENTS

### First Embodiment

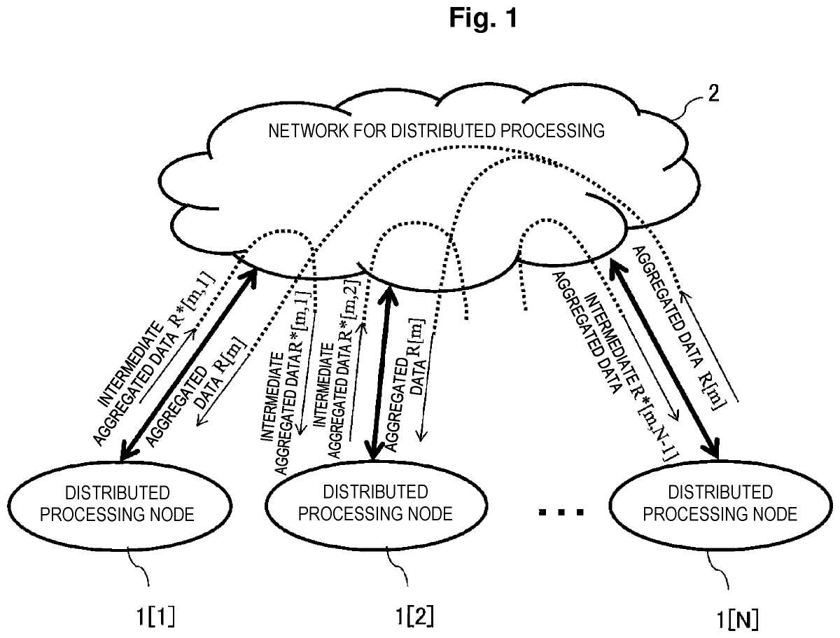

Embodiments of the present invention are explained below with reference to the drawings. FIG. 1 is a block diagram showing a configuration example of a distributed processing system for deep learning according to a first embodiment of the present invention. The distributed processing system shown in FIG. 1 includes N (N is an integer equal to or larger than 2) distributed processing nodes 1[n] (n=1, . . . , and N) provided for each of sets of sample data (learning data) of a neural network and a network for distributed processing 2 for transferring intermediate aggregated data R*[m,j] from distributed processing nodes 1[j] (j=1, . . . , and N−1) to a distributed processing node 1[j+1] and distributing aggregated data R[m] from a distributed processing node 1[N] to the distributed processing nodes 1[j] (j=1, . . . , and N−1). The network for distributed processing 2 is a network capable of performing bidirectional communication. Note that, in embodiments of the present invention, “node” means an apparatus such as a server disposed on a network in a distributed manner.

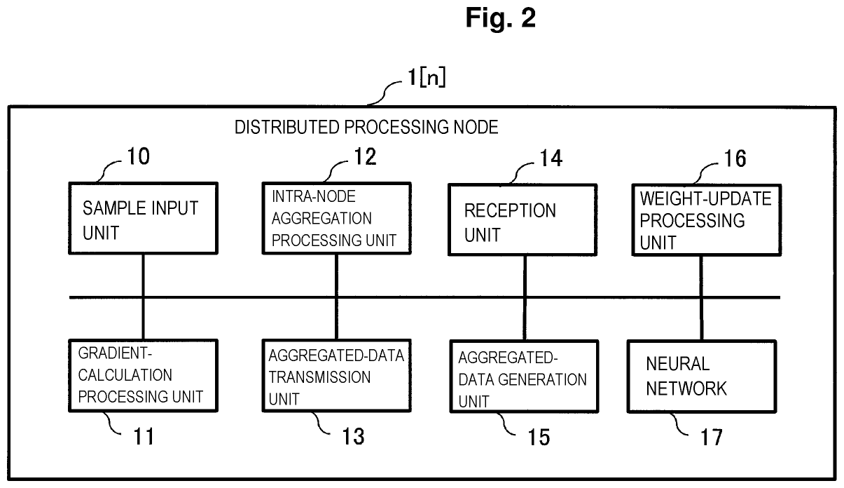

FIG. 2 is a block diagram showing a configuration example of the distributed processing node 1[n]. Each of the distributed processing nodes 1[n] includes a sample input unit 10 that receives sample data for learning from a not-shown data collection node, a gradient-calculation processing unit 11 that, when the sample data is input, concerning each of weights of a neural network, calculating for each of the sample data, a gradient of a loss function of the neural network, an intra-node aggregation processing unit 12 that generates, for each of the weights, and retains distributed data, which is a numerical value obtained by aggregating a gradient of each of the sample data, an aggregated-data transmission unit 13 that transmits intermediate aggregated data and aggregated data, a reception unit 14 that receives the intermediate aggregated data and the aggregated data, an aggregated-data generation unit 15 that generates the intermediate aggregated data when an own node is an intermediate distributed processing node and generates the aggregated data when the own node is a last distributed processing node, a weight-update processing unit 16 that updates the weights of the neural network based on the aggregated data, and a neural network 17, which is a mathematical model established in terms of software.

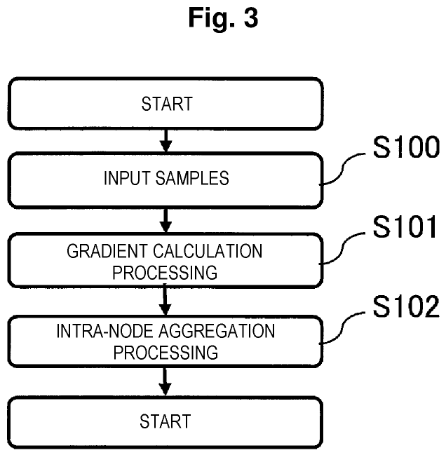

FIG. 3 is a flowchart for explaining sample data input processing, gradient calculation processing, and intra-node aggregation processing of the distributed processing node 1[n]. The sample input units 10 of the distributed processing nodes 1[n] (n=1, . . . , and N) input, for each of minibatches, different S (S is an integer equal to or larger than 2) sample data x[n,s] (s=1, . . . , and S) from a not-shown data collection node (step S100 in FIG. 3).

Note that embodiments of the present invention are not limited to a collection method for sample data by a data collection node and a method of allocating the collected sample data to N sets and distributing the sample data to the distributed processing nodes 1[n]. Embodiments of the present invention are applicable irrespective of these methods.

When the sample data x[n,s] is input, the gradient-calculation processing units 11 of the distributed processing nodes 1[n] (n=1 . . . , and N) calculate, concerning each of M (M is an integer equal to or larger than 2) weights w[m] (m=1, . . . , and M) of the learning target neural network 17, for each of the sample data x[n,s], a gradient G[m,n,s] of a loss function of the neural network 17 (step S101 in FIG. 3).

Detailed explanation is omitted concerning a method of constructing the neural network 17 in the distributed processing nodes 1[n] with software, the weights w[m] of the neural network 17, the loss function, which is an indicator indicating the poorness of the performance of the neural network 17, and the gradient G[m,n,s] of the loss function because these are the well-known techniques.

Subsequently, the intra-node aggregation processing units 12 of the distributed processing nodes 1[n] (n=1, . . . , and N) generate, for each of the weights w[m], and retains distributed data D[m,n], which is a numerical value obtained by aggregating the gradient G[m,n,s] of each of the sample data (step S102 in FIG. 3). A calculation formula for the distributed data D[m,n] is as follows.

[Formula 1]

D[m,n]=Σ_{s=1, . . . ,S}G[m,n,s] (1)

Note that the gradient calculation processing by the gradient-calculation processing unit 11 and the intra-node aggregation processing by the intra-node aggregation processing unit 12 can be pipelined in sample data units (the gradient calculation processing can be executed for certain sample data and, at the same time, the intra-node aggregation processing for aggregating a gradient obtained from sample data immediately preceding the sample data can be executed).

Further, after generating the distributed data D[m,n], the distributed processing nodes 1[n] (n=1, . . . , and N) perform aggregated communication among the distributed processing nodes and perform inter-node aggregation processing for generating aggregated data.

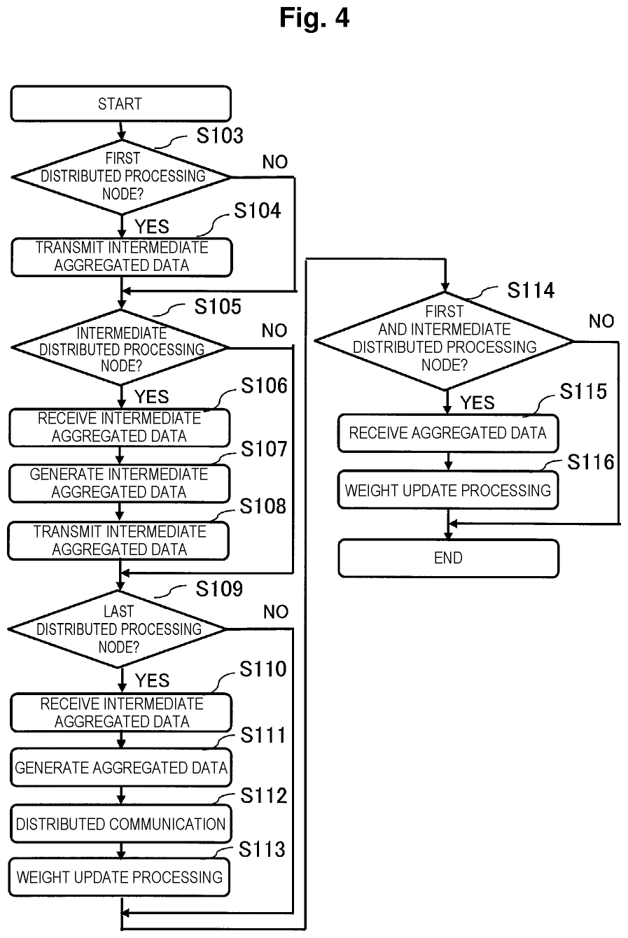

FIG. 4 is a flowchart for explaining the aggregated communication processing, the inter-node aggregation processing, and the weight update processing of the distributed processing node 1[n].

First, the aggregated-data transmission unit 13 of a predetermined first distributed processing node 1[1] among the plurality of distributed processing nodes 1[n] (n=1, . . . , and N) transmits, as intermediate aggregated data R*[m,], M distributed data D[m,1](m=1, . . . , and M) generated in the own node to a predetermined distributed processing node 1[2] of the next order via the network 2 for distributed processing (steps S103 and S104 in FIG. 4). That is, the intermediate aggregated data R*[m,1] at this time is the same as the distributed data D[m,1].

[Formula 2]

R*[m,1]=D[m,1] (2)

Subsequently, the reception unit 14 of a predetermined intermediate distributed processing node 1[i] (i=2, . . . , and N−1) excluding the first distributed processing node and a last distributed processing node among the plurality of distributed processing nodes 1[n] (n=, . . . , and N) receives intermediate aggregated data R*[m,i−1] from a distributed processing node 1[i−1] via the network for distributed processing 2 (steps S105 and S106 in FIG. 4).

The aggregated-data generation unit 15 of the intermediate distributed processing node 1[i] calculates, for each of the weights w[m] corresponding thereto, a sum of the received intermediate aggregated data R*[m,i−1] and distributed data D[m,i] generated by the own node to thereby generate intermediate aggregated data R*[m,i] (step S107 in FIG. 4). That is, the intermediate aggregated data R[m,i] is formed by M numerical values. A calculation formula for the intermediate aggregated data R*[m,i] is as follows.

[Formula 3]

R*[m,i]=R*[m,i−1]+D[m,i] (3)

The aggregated-data transmission unit 13 of the intermediate distributed processing node 1[i] transmits the intermediate aggregated data R*[m,i] generated by the own node to a predetermined distributed processing node 1[i+1] of the next order via the network for distributed processing 2 (step S108 in FIG. 4).

The reception unit 14 of a predetermined last distributed processing node 1[N] among the plurality of distributed processing nodes 1[n] (n=1, . . . , and N) receives intermediate aggregated data R*[m,N−1] from a distributed processing node 1[N−1] via the network for distributed processing 2 (steps S109 and S110 in FIG. 4).

The aggregated-data generation unit 15 of the last distributed processing node 1[N] calculates, for each of the weights w[m] corresponding thereto, a sum of the received intermediate aggregated data R*[m,N−1] and distributed data D[m,N] generated by the own node to thereby generate the aggregated data R[m] (step S111 in FIG. 4). That is, the aggregated data R[m] is formed by M numerical values. A calculation formula for the aggregated data R[m] is as follows.

[Formula 4]

R[m]=R*[m,N−1]+D[m,N] (4)

In this way, the aggregated data R[m](m=, . . . , and M) formed by the M numerical values calculated by Formula (2), Formula (3), and Formula (4) is calculated based on the distributed data D[m,n] formed by the M numerical values generated by the distributed processing nodes 1[n] (n=1, . . . , and N). A value of the aggregated data R[m] can be represented by the following formula.

[Formula 5]

R[m]=Σ_{n=1, . . . ,N}D[m,n] (5)

The aggregated-data transmission unit 13 of the last distributed processing node 1[N] performs distributed communication for distributing the aggregated data R[m] generated by the own node to the first and intermediate distributed processing nodes 1[j](j=1, . . . , and N−1) via the network for distributed processing 2 (step S112 in FIG. 4).

The weight-update processing unit 16 of the last distributed processing node 1[N] performs, based on the aggregated data R[m] generated by the own node, weight update processing for updating the weights w[m] of the neural network 17 in the own node (step S113 in FIG. 4). In the weight update processing, the weight-update processing unit 16 only has to update the weights w[m] for each of numbers m to minimize a loss function based on a gradient of the loss function indicated by the aggregated data R[m]. Detailed explanation of the update of the weights w[m] is omitted because the update of the weights w[m] is the well-known technique.

In this way, the weight update processing is processing for updating the weights w[m] based on the aggregated data R[m] acquired in the order of the numbers m of the weights w[m]. Accordingly, the distributed processing node 1[N] can perform the weight update processing for the weights w[m] in the order of the numbers m.

On the other hand, the reception units 14 of the first and intermediate distributed processing nodes 1[j] (j=1, . . . , and N−1) receive the aggregated data R[m] from the distributed processing node 1[N] via the network for distributed processing 2 (steps S114 and S115 in FIG. 4). According to the distributed communication, the first and intermediate distributed processing nodes 1[j] can acquire the same aggregated data R[m].

The weight-update processing units 16 of the first and intermediate distributed processing nodes 1[j] perform, based on the received aggregated data R[m], weight update processing for updating the weights w[m] of the neural network 17 in the own node (step S116 in FIG. 4). The weight update processing is the same as the weight update processing in the last distributed processing node 1[N].

According to an end of the weight update processing, one minibatch learning ends. The distributed processing nodes 1[n] (n=1, . . . , and N) continuously perform processing of the next minibatch learning based on the updated weights. That is, the distributed processing nodes 1[n] receive sample data for the next minibatch learning from a not-shown data collection node and repeat the processing of the minibatch learning explained above to thereby improve inference accuracy of the neural network 17.

In the above explanation, operation for processing the M distributed data D[m,n] at a time is explained. However, actually, the M distributed data D[m,n] is allocated to a plurality of packets and pipeline processing is performed.

A procedure in the processing of the distributed processing nodes 1[n] (n=1, . . . , and N) (operation for performing the pipeline processing in the order of the numbers m of the weights w[m]) is explained below.

The aggregated-data transmission unit 13 of a predetermined first distributed processing node 1[1] among the plurality of distributed processing nodes 1[n] (n=1, . . . , and N) performs aggregated communication for transmitting, as the intermediate aggregated data R*[m,1], the M distributed data D[m,1] (m=1, . . . , and M) generated by the own node to a predetermined distributed processing node 1[2] of the next order via the network for distributed processing 2 (steps S103 and S104 in FIG. 4).

At this time, the aggregated-data transmission unit 13 of the distributed processing node 1[i] allocates retained intermediate aggregated data R*[m,1] (=D[m,1]) to P (P is an integer equal to or larger than 2) aggregated communication packets by L (L is an integer equal to or larger than 1 and smaller than M) intermediate aggregated data R*[m,] at a time in the order of the numbers m of the weights w[m] and transmits the P aggregated communication packets to the distributed processing node 1[2] of the next order until finishing transmitting all the aggregated communication packets. That is, L intermediate aggregated data R*[r,1] (r=L×(p−1)+l, l=1, . . . , and L) are stored in a p-th (p=1, . . . , and P) aggregated communication packet SP[p,1] to be transmitted.

Note that, under a condition in which M cannot be divided by L, (M−L×(P−1)) intermediate aggregated data R*[r,1] (r=L×(P−1)+q, q=1, . . . , and M−L×(P−1)) are stored in a P-th aggregated communication packet SP[P,1].

Concerning the P-th aggregated communication packet SP[P,1], {L−(M−L×(P−1))}dummy numerical values may be added after the (M−L×(P−1)) intermediate aggregated data R*[r,1] such that all the aggregated communication packets equally store L data.

Subsequently, the reception unit 14 of the intermediate distributed processing node 1[i] (i=2, . . . , and N−1) excluding the first and last distributed processing nodes among the plurality of distributed processing nodes 1[n] (n=1 . . . , and N) receives an aggregated communication packet SP[p,i−1] (p=1, . . . , and P) from the distributed processing node 1[i−1](steps S105 and S106 in FIG. 4).

The reception unit 14 of the intermediate distributed processing node 1[i] acquires, from the received aggregated communication packet SP[p,i−1], L intermediate aggregated data R*[r,i−1] (r=L×(p−1)+l, l=1, . . . , and L) generated by the distributed processing node 1[i−1] at a transmission source. Since P aggregated communication packets SP[p,i−1] (p=1, . . . , and P) are transmitted from the distributed processing node 1[i−1] in order, the reception unit 14 of the intermediate distributed processing node 1[i] can finally acquire M intermediate aggregated data R*[m,i−1].

The aggregated-data generation unit 15 of the intermediate distributed processing node 1[i] calculates, for each of the weights w[m] corresponding thereto, a sum of the acquired intermediate aggregated data R*[m,i−1] and the distributed data D[m,i] generated by the own node (Formula (3)) to thereby generate the intermediate aggregated data R*[m,i] (step S107 in FIG. 4).

Subsequently, the aggregated-data transmission unit 13 of the intermediate distributed processing node 1[i] performs aggregated communication for transmitting M intermediate aggregated data R*[m,i] (m=1, . . . , and M) generated by the own node to the predetermined distributed processing node 1[i+1] of the next order via the network for distributed processing 2 (step S108 in FIG. 4).

At this time, the aggregated-data transmission unit 13 of the distributed processing node 1[i] allocates the generated M intermediate aggregated data R*[m,i] to the P aggregated communication packets by L intermediate aggregated data R*[m,i] at a time in the order of the numbers m of the weights w[m] and transmits the P aggregated communication packets in order to the distributed processing node 1[i+1] of the next order until finishing transmitting all the aggregated communication packets. That is, L intermediate aggregated data R*[r,i] (r=L×(p−1)+l, l=1, . . . , and L) are stored in a p-th (p=1, . . . , and P) aggregated communication packet SP[p,i] to be transmitted.

Note that, under a condition in which M cannot be divided by L, (M−L×(P−1)) intermediate aggregated data R*[r,i] (r=L×(P−1)+q, q=1, . . . , and M−L×(P−1)) are stored in a P-th aggregated communication packet SP[P,i].

Concerning the P-th aggregated communication packet SP[P,i], {L−(M−L×(P−1))}dummy numerical values may be added after the (M−L×(P−1)) intermediate aggregated data R*[r,i] such that all the aggregated communication packets equally store L data.

The reception unit 14 of the predetermined last distributed processing node 1[N] among the plurality of distributed processing nodes 1[n] (n=1, . . . , and N) receives the aggregated communication packet SP[p,N−1] (p=1, . . . , and P) from the distributed processing node 1[N−1](steps S109 and S111 in FIG. 4).

The reception unit 14 of the last distributed processing node 1[N] acquires L intermediate aggregated data R*[r,N−1] (r=L×(p−1)+l, l=1, . . . , and L) generated by the distributed processing node 1[N−1] at a transmission source. Since P aggregated communication packets SP[p,N−1] (p=1, . . . , and P) are transmitted from the distributed processing node 1[N−1] in order, the reception unit 14 of the last distributed processing node 1[N] can finally acquire M intermediate aggregated data R*[m,N−1].

The aggregated-data generation unit 15 of the last distributed processing node 1[N] calculates, for each of the weights w[m] corresponding thereto, a sum of the acquired intermediate aggregated data R*[m,N−1] and the distributed data D[m,N] generated by the own node (Formula (4)) to thereby generate aggregated data R[m] (step S111 in FIG. 4).

Subsequently, the aggregated-data transmission unit 13 of the last distributed processing node 1[N] performs distributed communication for packetizing the aggregated data R[m] (m=1, . . . , and M) generated by the own node in the order of the numbers m of the weights w[m] and distributing the packet to the first and intermediate distributed processing nodes 1[j](j=1, . . . , and N−1) (step S112 in FIG. 4).

At this time, the aggregated-data transmission unit 13 of the distributed processing node 1[N] allocates the generated M aggregated data R[m] (m=1, . . . , and M) to the P distributed communication packets by L aggregated data R[m] at a time in the order of the numbers m of the weights w[m] and transmits the P distributed communication packets in order to the distributed processing nodes 1[j] of the next order until finishing transmitting all the distributed communication packets. That is, L aggregated data R[r] (r=L×(p−1)+l, l=1, . . . , and L) are stored in a p-th (p=1, . . . , and P) distributed communication packet DP[p] to be transmitted.

Note that, under a condition in which M cannot be divided by L, (M−L×(P−1)) aggregated data R[r] (r=L×(P−1)+q, q=1, . . . , and M−L×(P−1)) are stored in a P-th distributed communication packet DP[p].

Concerning the P-th distributed communication packet DP[p], {L−(M−L×(P−1))}dummy numerical values may be added after the (M−L×(P−1)) aggregated data R[r] such that all the distributed communication packets equally store L data.

The reception units 14 of the first and intermediate distributed processing nodes 1[j] (j=1, . . . , and N−1) receive the distributed communication packet DP[p] (p=1, . . . , and P) from the distributed processing node 1[N] (steps S114 and S115 in FIG. 4).

The reception units 14 of the first and intermediate distributed processing nodes 1[j] acquire, from the received distributed communication packet DP[p], the L aggregated data R[r](r=L×(p−1)+l, l=1, . . . , and L) generated by the distributed processing node 1[N] at a transmission source. Since P distributed communication packets DP[p] (p=1, . . . , and P) are transmitted in order from the distributed processing node 1[N], the reception units 14 of the first and intermediate distributed processing nodes 1[j] can finally acquire M aggregated data R[m].

The weight update processing in the distributed processing nodes 1[n] is as explained above.

In this way, all of the aggregated communication from the distributed processing node 1[j] (j=1, . . . , and N−1) to the distributed processing node 1[j+1] (the processing for transmitting the intermediate aggregated data R*[m,j] to the distributed processing node 1[j+1]), the inter-node aggregation processing performed by the intermediate distributed processing node 1[i] (i=2, . . . , and N−1) (the processing for calculating the intermediate aggregated data R*[m,i] based on the received intermediate aggregated data R*[m,i−1] and the distributed data D[m,i] generated by the own node), the inter-node aggregation processing performed by the distributed processing node 1[N] (the processing for calculating the aggregated data R[m] based on the received intermediate aggregated data R*[m,N−1] and the distributed data D[m,N] generated by the own node), and the distributed communication from the distributed processing node 1[N] to the distributed processing node 1[j] (j=1, . . . , and N−1 (the processing for distributing the aggregated data R[m] to the distributed processing node 1[j]) are performed in the order of the numbers m of the weights w[m] and can be pipelined with the numbers m as units.

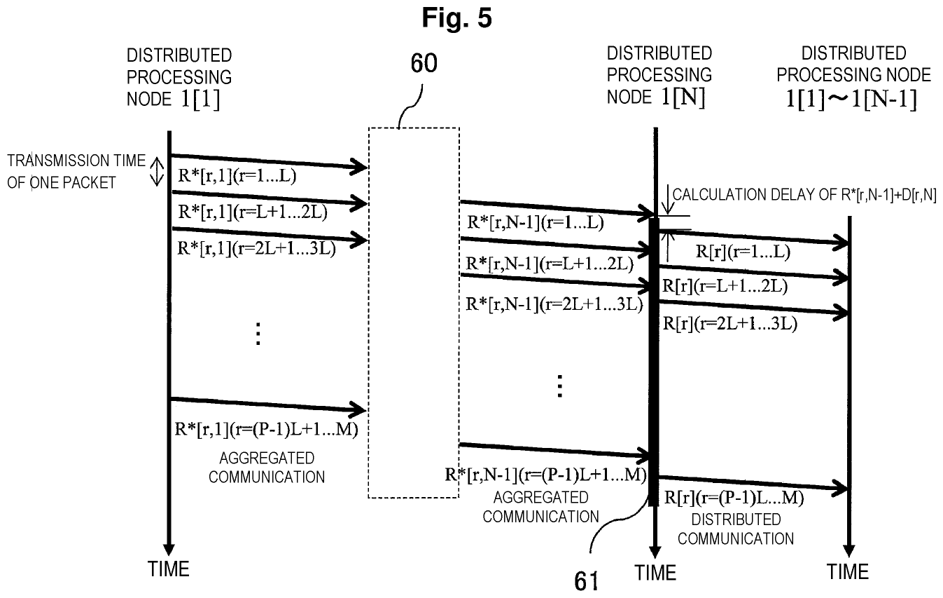

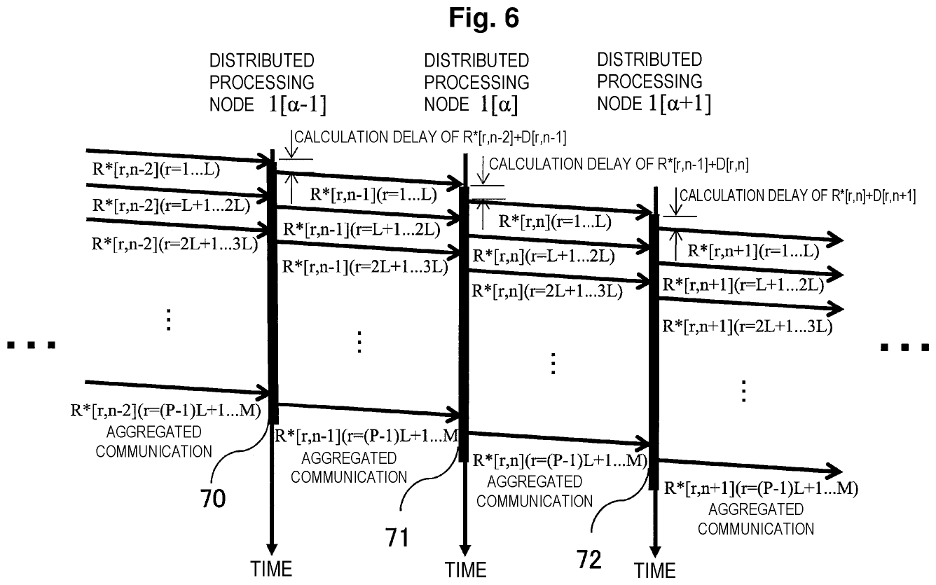

A sequence of processing of the distributed processing nodes 1[n] (n=1, . . . , and N) is shown in FIG. 5 and FIG. 6. Note that FIG. 6 shows processing in a part of box 60 in FIG. 5. The reference numeral 61 indicates the inter-node aggregation processing in the distributed processing node 1[N]. Similarly, the reference numerals 70, 71, and 72 in FIG. 6 indicate the inter-node aggregation processing in distributed processing nodes 1[α−1], 1[α], and i[α+1] (α=3, . . . , and N−2).

In this embodiment, as shown in FIG. 5 and FIG. 6, the aggregated communication processing, the inter-node aggregation processing, and the distributed communication processing can be substantially simultaneously performed in parallel (in pipeline processing). Compared with related art in which the next processing cannot be started until each communication or each processing ends, it is possible to greatly reduce a processing time.

Therefore, for example, when a time T is required in each of the aggregated communication processing, the inter-node aggregation processing, and the distributed communication processing, in related art, the respective kinds of processing are performed in order with all data as units. Therefore, a time of 3T is required to end all of these kinds of processing. However, in this embodiment, only a time of T+α is required. The reference sign a indicates a delay time from a point in time when any distributed processing node 1[n] transmits the distributed data D[m,n] corresponding to any numbers m until the distributed processing node 1[n] receives the aggregated data R[m] corresponding to the numbers m. In this embodiment, since the processing is pipelined in the units of the numbers m, the time a is a sufficiently small time compared with T. Therefore, in this embodiment, compared with related art, the time required for the aggregated communication processing, the inter-node aggregation processing, and the distributed communication processing can be reduced to approximately one third.

### Second Embodiment

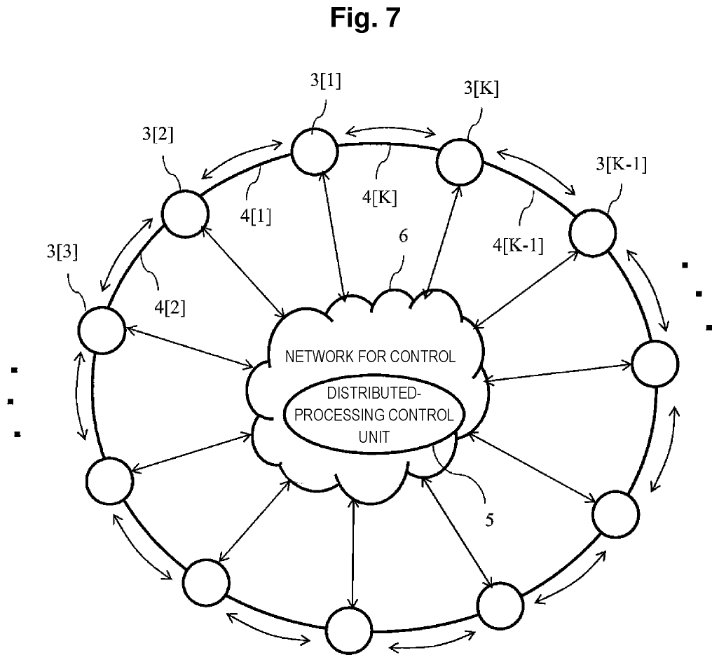

A second embodiment of the present invention is explained. A configuration example of a distributed processing system for deep learning in this embodiment is shown in FIG. 7. The distributed processing system shown in FIG. 7 includes K (K is an integer equal to or larger than 3) ring nodes 3[k] (k=1, . . . , and K), a communication path 4[k] (k=1, . . . , and K) for the ring node 3[k] (k=1, . . . , and K) having a number k to bidirectionally communicate with a ring node 3[k+] having a next number k+ (k+=k+1; in the case of k=K, k+=1), a distributed-processing control unit 5, and a network for control 6.

The distributed-processing control unit 5 is connected to the ring nodes 3[k] (k=1, . . . , and K) via the network for control 6. The distributed-processing control unit 5 designates, to the ring nodes 3[k] (k=1, . . . , and K), functions of the ring nodes as a distributed processing node or a relay node via the network for control 6. However, in this designation, the ring node designated as the distributed processing node needs to be designated such that the ring node is connected to distributed processing nodes having preceding and following numbers via at least one of one or more communication paths 4 and one or more relay nodes.

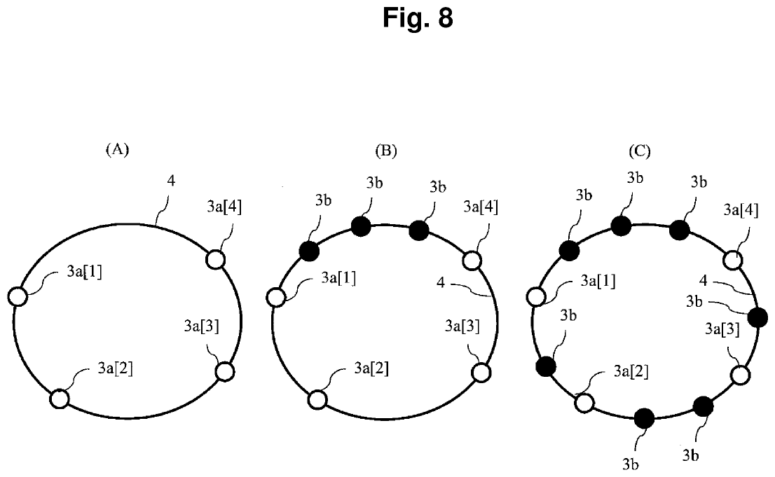

In FIG. 8(A), FIG. 8(B), and FIG. 8(C), an example of a state in which the ring nodes 3[k] (k=1, . . . , and K) are designated as a distributed processing node 3a[n] (n=1, . . . , and N; in this embodiment, N is an integer equal to or larger than 2 and equal to or smaller than K) or a relay node 3b.

FIG. 8(A) shows the case of K=N=4. All ring nodes 3[4] are designated as any one of the distributed processing nodes 3a[n] (n=1, . . . , and N). No ring node is designated as the relay node. The ring nodes respectively designated as a distributed processing node 3a[j] (j=1, . . . , and N−1) and a distributed processing node 3a[j+1] are connected via only one communication path 4.

FIG. 8(B) shows the case of K>N=4. The number of the ring nodes 3 designated as the relay node 3b is (K−N) (K=7). However, as in FIG. 8(A), the ring nodes respectively designated as the distributed processing node 3a[j] (j=1, . . . , and N−1) and the distributed processing node 3a[j+1] are connected via only one communication path 4 and not via the relay node 3b. Only a ring node present between a distributed processing node 3a[1] and a distributed processing node 3a[N] is designated as the relay node 3b.

FIG. 8(C) shows the case of K>N=4. As in FIG. 8(B), the number of the ring nodes 3 designated as the relay node is (K−N) (K=11). However, FIG. 8(C) is different from FIG. 8(B) in that the ring nodes 3 respectively designated as a distributed processing node 3a[z] (z is an integer equal to or larger than 1 and equal to or smaller than N−1) and a distributed processing node 3a[z+1] are connected via one or more communication paths 4 and one or more relay nodes 3b.

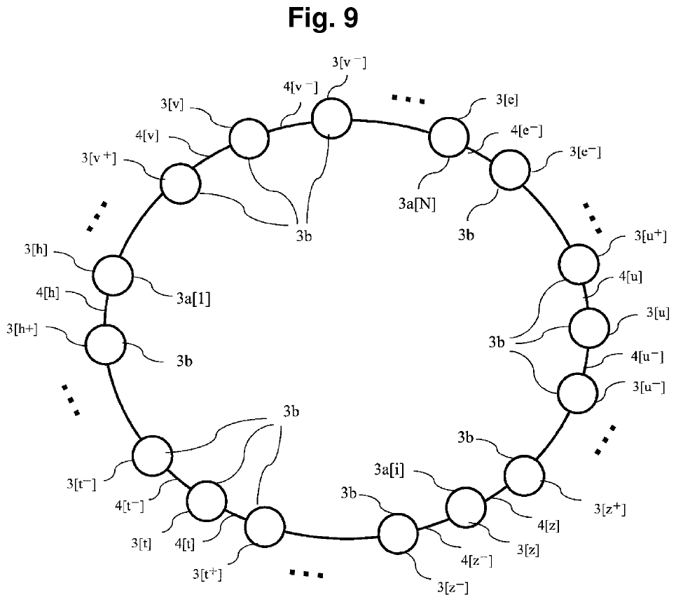

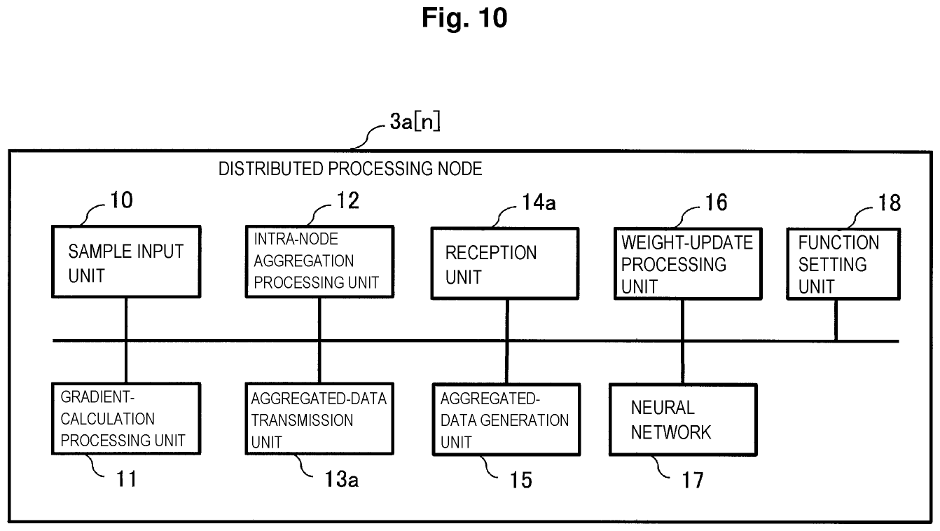

FIG. 9 is an example in which a system equivalent to the distributed processing system explained in the first embodiment is configured by designating the ring nodes 3 as the distributed processing node 3a[n] or the relay node 3b. FIG. 10 is a block diagram showing a configuration example of the distributed processing node 3a[n]. The same components as the components shown in FIG. 2 are denoted by the same reference numerals and signs. Each of the distributed processing nodes 3a[n] includes the sample input unit 10, the gradient-calculation processing unit 11, the intra-node aggregation processing unit 12, an aggregated-data transmission unit 13a, a reception unit 14a, the aggregated-data generation unit 15, the weight-update processing unit 16, the neural network 17, and a function setting unit 18 that receives designation from the distributed-processing control unit 5 and sets a function of the own node as a distributed processing node or a relay node. Note that the function setting unit 18 receives, from the distributed-processing control unit 5, addresses of all the distributed processing nodes 3a including addresses of the distributed processing nodes 3a having numbers preceding and following the own distributed processing node.

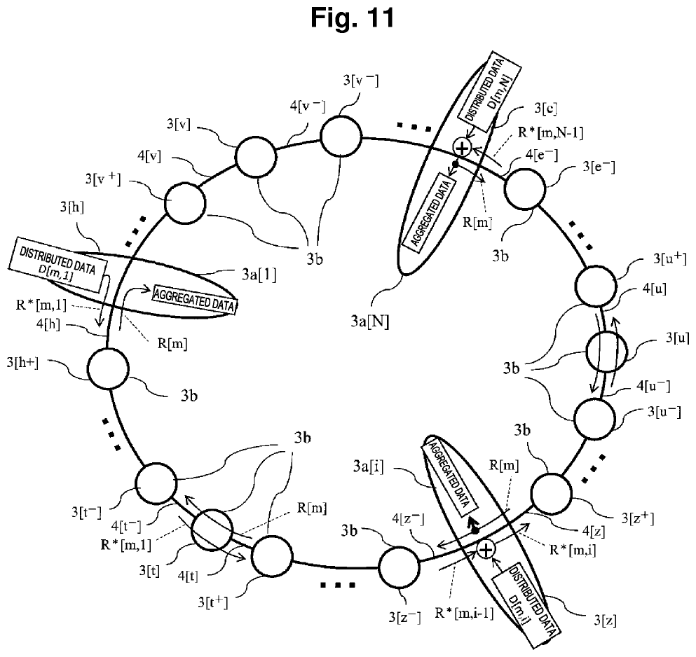

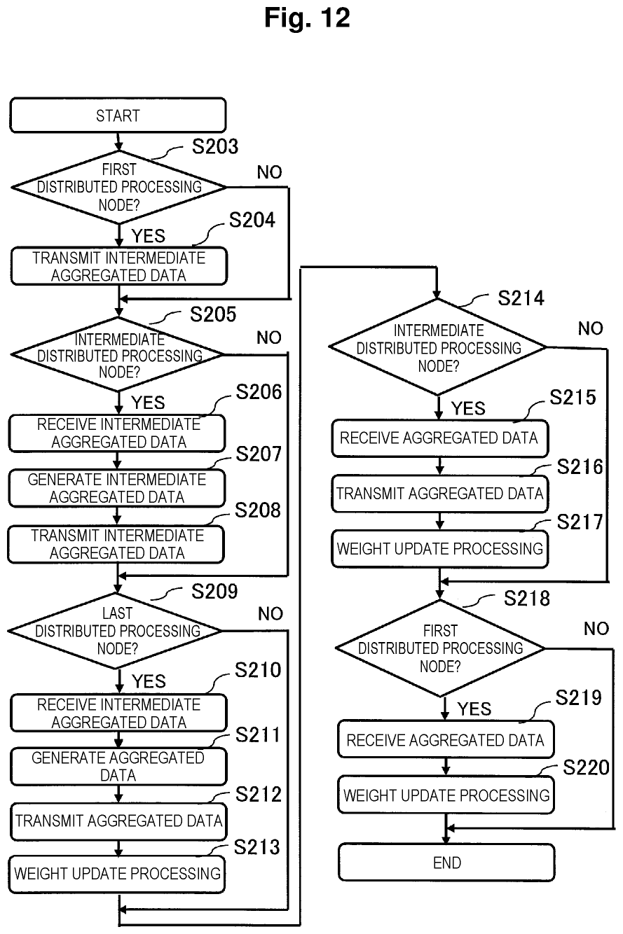

FIG. 11 is a diagram for explaining the operation of the distributed processing system for deep learning shown in FIG. 9. FIG. 12 is a flowchart for explaining aggregated communication processing, inter-node aggregation processing, and weight update processing of the distributed processing nodes 3a[n]. Sample data input processing, gradient calculation processing, and intra-node aggregation processing of the distributed processing nodes 3a[n] are the same as those in the first embodiment.

The intra-node aggregation processing unit 12 of a ring node 3[h] functioning as a first distributed processing node 3a[1] generates the distributed data D[m,1] (m=1, . . . , and M) as in the first embodiment.

The aggregated-data transmission unit 13a of the distributed processing node 3a[1]transmits, as the intermediate aggregated data R*[m,1], M distributed data D[m,1] generated by the own node to a ring node 3[h+] (h+=h+1; in the case of h=K, h+=1) having the next number via a communication path 4[h] (steps S203 and S204 in FIG. 12). That is, the aggregated-data transmission unit 13a transmits the intermediate aggregated data R*[m,1] to a distributed processing node 3a[2] having the next number.

A ring node 3[t] functioning as the relay node 3b transfers, to a ring node 3[t+] having a following number t+ (t+=t+1; in the case of t=K, t+=1), via a communication path 4[t], an intermediate aggregated data R* received from a ring node 3[t−] having a preceding number t− (t−=t−1; in the case of t=1, t−=K) via a communication path 4[t−]. A ring node 3[u] functioning as the relay node 3b is the same as the ring node 3[t].

The intra-node aggregation processing unit 12 of the ring node 3[z] functioning as an intermediate distributed processing node 3a[i] (i=2, . . . , and N−1) excluding first and last distributed processing nodes generates the distributed data D[m,i] (m=1, . . . , and M) as in the first embodiment.

The reception unit 14a of the intermediate distributed processing node 3a[i] receives the intermediate aggregated data R*[m,i−1] from a ring node 3[z−] having a preceding number z−(z−=z−1; in the case of z=1, z−=K) via a communication path 4[z−] (steps S205 and S206 in FIG. 12).

The aggregated-data generation unit 15 of the intermediate distributed processing node 3a[i] calculates, for each of the weights w[m] corresponding thereto, a sum of the received intermediate aggregated data R*[m,i−1] and the distributed data D[m,i] generated by the own node to thereby generate the intermediate aggregated data R*[m,i] (step S207 in FIG. 12).

The aggregated-data transmission unit 13a of the intermediate distributed processing node 3a[i] transmits the intermediate aggregated data R*[m,i] generated by the own node to a ring node 3[z+] having a next number z+ (z+=z+1; in the case of z=K, z+=1) via the communication path 4[z] (step S208 in FIG. 12). That is, the aggregated-data transmission unit 13a transmits the intermediate aggregated data R*[m,i] to a distributed processing node 3a[i+1] having the next number.

The intra-node aggregation processing unit 12 of a ring node 3(e) functioning as a last distributed processing node 3a[N] generates the distributed data D[m,N] (m=1, . . . , and M) as in the first embodiment.

The reception unit 14a of the last distributed processing node 3a[N] receives the intermediate aggregated data R*[m,N−1] from a ring node 3[e−] having a preceding number e−(e−=e−1; in the case of e=1, e−=K) via a communication path 4[e−] (steps S209 and S210 in FIG. 12).

The aggregated-data generation unit 15 of the last distributed processing node 3a[N] calculates, for each of the weights w[m] corresponding thereto, a sum of the received intermediate aggregated data R*[m,N−1] and the distributed data D[m,N] generated by the own node to thereby generate the aggregated data R[m] (step S211 in FIG. 12).

The aggregated-data transmission unit 13a of the last distributed processing node 3a[N] transmits the aggregated data R[m] generated by the own node to the ring node 3[e−] having the preceding number e− (step S212 in FIG. 12). That is, the aggregated-data transmission unit 13a transmits the aggregated data R[m] to a distributed processing node 3a[N−1] having a preceding number. The operation (step S213 in FIG. 12) of the weight-update processing unit 16 of the last distributed processing node 3a[N] is the same as the operation in the first embodiment.

The ring node 3[t] functioning as the relay node 3b transfers, to the ring node 3[t−] having the preceding number t− (t−=t−1; in the case of t=1, t−==K), via the communication path 4[t−], the aggregated data R[m] received from the ring node 3[t+] having the following number t+ (t+=t+1; in the case of t=K, t+=1) via a communication path 4[t+]. The ring node 3[u] functioning as the relay node 3b is the same as the ring node 3[t].

The reception unit 14a of a ring node 3[z] functioning as the intermediate distributed processing node 3a[i] (i=2, . . . , and N−1) receives the aggregated data R[m] from a ring node 3[z+] having a following number z+ (z+=z+1; in the case of z=K, z+=1) via a communication path 4[z+] (steps S214 and S215 in FIG. 12).

The aggregated-data transmission unit 13a of the intermediate distributed processing node 3a[i] transmits, via the communication path 4[z−], the aggregated data R[m] to the ring node 3[z−] having the preceding number z− (z−=z−1; in the case of z=1, z−=K) (step S216 in FIG. 12). That is, the aggregated-data transmission unit 13a transmits the aggregated data R[m] to a distributed processing node 3a[i−1] having a preceding number. The operation (step S217 in FIG. 12) of the weight-update processing unit 16 of the intermediate distributed processing node 3a[i] is the same as the operation in the first embodiment.

The reception unit 14a of the ring node 3[h] functioning as the first distributed processing node 3a[1] receives the aggregated data R[m] from the ring node 3[h+] having a following number h+ (h+=h+; in the case of h=K, h+=1) via a communication path 4[h+] (steps S218 and S219 in FIG. 12). The operation (step S220 in FIG. 12) of the weight-update processing unit 16 of the first distributed processing node 3a[1] is the same as the operation in the first embodiment.

Note that the ring node 3[v] functioning as the relay node 3b is located between the distributed processing node 3a[1] and the distributed processing node 3a[n]. Therefore, in this embodiment, the ring node 3[v] does not transfer intermediate aggregated data and aggregated data.

According to an end of the weight update processing, one minibatch learning ends. The distributed processing nodes 3a[n] (n=1, . . . , and N) continuously perform processing of the next minibatch learning based on updated weights. That is, the distributed processing nodes 3a[n] receive sample data for the next minibatch learning from a not-shown data collection node and repeat the processing of the minibatch learning explained above to thereby improve inference accuracy of the neural network 17.

In the above explanation, the operation for processing the M distributed data D[m,n] at a time is explained. However, actually, as in the first embodiment, the M distributed data D[m,n] are allocated to a plurality of packets to perform pipeline processing.

A procedure in processing of the distributed processing nodes 3a[n] (n=1, . . . , and N) (operation for performing the pipeline processing in the order of the numbers m of the weights w[m]) is explained below.

The aggregated-data transmission unit 13a of the first distributed processing node 3a[1] transmits, as the intermediate aggregated data R*[m,1], the M distributed data D[m,1](m=1, . . . , and M) generated by the own node to a ring node 3[h+] having the next number (steps S203 and S204 in FIG. 12).

At this time, the aggregated-data transmission unit 13a of the first distributed processing node 3a[1] allocates the retained M intermediate aggregated data R*[m,1] (=D[m,1]) to the P aggregated communication packets by L intermediate aggregated data R*[m,1] at a time in the order of the numbers m of the weights w[m] and transmits the P aggregated communication packets in order to the ring node 3[h+] having the next number until finishing transmitting all the aggregated communication packets. That is, L intermediate aggregated data R*[r,1] (r=L×(p−1)+l, l=1, . . . , and L) are stored in a p-th (p=1, . . . , and P) aggregated communication packet SP[p,1] to be transmitted.

Note that, under a condition in which M cannot be divided by L, (M−L×(P−1)) intermediate aggregated data R*[r,1] (r=L×(P−1)+q, q=1, . . . , and M−L×(P−1)) are stored in the P-th aggregated communication packet SP[P,1].

Concerning the P-th aggregated communication packet SP[P,1], {L−(M−L×(P−1))}dummy numerical values may be added after the (M−L×(P−1)) intermediate aggregated data R*[r,1] such that all the aggregated communication packets equally store L data.

The reception units 14a of the intermediate distributed processing nodes 3a[i] (i=2, . . . , and N−1) excluding the first and last intermediate distributed processing nodes receive the aggregated communication packets SP[p,i−1] (p=1, . . . , and P) transmitted by the distributed processing node 3a[i−1] (steps S205 and S206 in FIG. 12).

The reception unit 14a of the intermediate distributed processing node 3a[i] acquires, from the received aggregated communication packet SP[p,i−1], the L intermediate aggregated data R*[r,i−1] (r=L×(p−1)+l, l=1, . . . , and L) generated by the distributed processing node 3a[i−1] at a transmission source. Since the P aggregated communication packets SP[p,i−1](p=1, . . . , and P) are transmitted in order from the distributed processing node 3a[i−1], the reception unit 14a of the intermediate distributed processing node 3a[i] can finally acquire the M intermediate aggregated data R*[m,i−1].

The aggregated-data generation unit 15 of the intermediate distributed processing node 3a[i] calculates, for each of the weights w[m] corresponding thereto, a sum of the acquired intermediate aggregated data R*[m,i−1] and the distributed data D[m,i] generated by the own node (Formula (3)) to thereby generate the intermediate aggregated data R*[m,i] (step S207 in FIG. 12).

Subsequently, the aggregated-data transmission unit 13a of the intermediate distributed processing node 3a[i] performs aggregated communication for transmitting the M intermediate aggregated data R*[m,i] (m=1, . . . , and M) generated by the own node to the ring node 3[z+] having the next number z+ (step S208 in FIG. 12).

At this time, the aggregated-data transmission unit 13a of the distributed processing node 3a[i] allocates the generated M intermediate aggregated data R*[m,i] to the P aggregated communication packets by L intermediate aggregated data R*[m,i] at a time in the order of the numbers m of the weights w[m] and transmits the P aggregated communication packets in order to the distributed processing node 3a[i+1] of the next order until finishing transmitting all the aggregated communication packets. That is, the L intermediate aggregated data R*[r,i] (r=L×(p−1)+l, l=1, . . . , and L) are stored in the p-th (p=1, . . . , and P) aggregated communication packets SP[p,i] to be transmitted.

Note that, under a condition in which M cannot be divided by L, the (M−L×(P−1)) intermediate aggregated data R*[r,i] (r=L×(P−1)+q, q=1, . . . , and M−L×(P−1)) are stored in the P-th aggregated communication packet SP[P,i].

Concerning the P-th aggregated communication packet SP[P,i], {L−(M−L×(P−1))}dummy numerical values may be added after the (M−L×(P−1)) intermediate aggregated data R*[r,i] such that all the aggregated communication packets equally store L data.

The reception unit 14a of the last distributed processing node 3a[N] receives the aggregated communication packet SP[p,N−1] (p=1, . . . , and P) transmitted by the distributed processing node 3a[N−1] (steps S209 and S210 in FIG. 12).

The reception unit 14a of the last distributed processing node 3a[N] acquires, from the received aggregated communication packet SP[p,N−1], the L intermediate aggregated data R*[r,N−1] (r=L×(p−1)+l, l=1, . . . , and L) generated by the distributed processing node 3a[N−1] at a transmission source. Since the P aggregated communication packets SP[p,N−1] (p=1, . . . , and P) are transmitted in order from the distributed processing node 3a[N−1], the reception unit 14a of the last distributed processing node 3a[N] can finally acquire the M intermediate aggregated data R*[m,N−1].

The aggregated-data generation unit 15 of the last distributed processing node 3a[N] calculates, for each of the weights w[m] corresponding thereto, a sum of the acquired intermediate aggregated data R*[m,N−1] and the distributed data D[m,N] generated by the own node (Formula (4)) to thereby generate the intermediate aggregated data R[m] (step S211 in FIG. 12).

Subsequently, the aggregated-data transmission unit 13a of the last distributed processing node 3a[N] performs distributed communication for packetizing the aggregated data R[m] (m=1, . . . , and M) generated by the own node in the order of the numbers m of the weights w[m] and transmitting the packet in order to the ring node 3[e−] having the preceding number e− (step S212 in FIG. 12).

At this time, the aggregated-data transmission unit 13a of the distributed processing node 3a[N] allocates the generated M aggregated data R[m] (m=1, . . . , and M) to the P distributed communication packets by L aggregated data R[m] at a time in the order of the numbers m of the weights w[m] and transmits the P distributed communication packets to the ring node 3[e−] having the preceding number e− until finishing transmitting all the distributed communication packets. That is, the L aggregated data R[r] (r=L×(p−1)+l, l=1, . . . , and L) are stored in a p-th (p=1, . . . , and P) distributed communication packet DP[p,N] to be transmitted.

Note that, under a condition in which M cannot be divided by L, the (M−L×(P−1)) aggregated data R[r] (r=L×(P−1)+q, q=1, . . . , and M−L×(P−1)) are stored in a P-th distributed communication packet DP[p,N].

Concerning the P-th distributed communication packet DP[p,N], {L−(M−L×(P−1))}dummy numerical values may be added after the (M−L×(P−1)) aggregated data R[r] such that all the distributed communication packets equally store L data.

Subsequently, the reception unit 14a of the intermediate distributed processing node 3a[i] (i=2, . . . , and N−1) receives a distributed communication packet DP[p,i−1] (steps S214 and S215 in FIG. 12).

The reception unit 14a of the intermediate distributed processing node 3a[i] acquires, from the received distributed communication packet DP[p,i−1], the L aggregated data R[r] (r=L×(p−1)+l, l=1, . . . , and L) generated by the distributed processing node 3a[i−1]. Since the P distributed communication packets DP[p,i−1] (p=1, . . . , and P) are transmitted in order from the distributed processing node 3a[i−1], the reception unit 14a of the intermediate distributed processing node 3a[i] can finally acquire the M aggregated data R[m].

Subsequently, the aggregated-data transmission unit 13a of the intermediate distributed processing node 3a[i] performs distributed communication for transmitting the acquired aggregated data R[m] (m=1, . . . , and M) to the ring node 3[z−] having the preceding number z− (step S216 in FIG. 12).

At this time, the aggregated-data transmission unit 13a of the distributed processing node 3a[i] allocates the M aggregated data R[m](m=, . . . , and M) to the P distributed communication packets by L aggregated data R[m] at a time in the order of the numbers m of the weights w[m] and transmits the P distributed communication packets in order to the ring node 3[z−] having the preceding number z− until finishing transmitting all the distributed communication packets. That is, the L aggregated data R[r] (r=L×(p−1)+l, l=1, . . . , and L) are stored in the p-th (p=1, . . . , and P) distributed communication packet DP[p,i] to be transmitted.

Note that, under a condition in which M cannot be divided by L, the (M−L×(P−1)) aggregated data R[r] (r=L×(P−1)+q, q=1, . . . , and M−L×(P−1)) are stored in the P-th distributed communication packet DP[P,i].

Concerning the P-th distributed communication packet DP[P,i], {L−(M−L×(P−1))}dummy numerical values may be added after the (M−L×(P−1)) aggregated data R[r] such that all the distributed communication packets equally store L data.

The reception unit 14a of the first distributed processing node 3a[1] receives a distributed communication packet DP[p,2] from the ring node 3[h+] having the following number h+ (steps S218 and S219 in FIG. 12).

The reception unit 14a of the first distributed processing node 3a[1] acquires, from the received distributed communication packet DP[p,2], the L aggregated data R[r] (r=L×(p−1)+l, l=1, . . . , and L) generated by the distributed processing node 3a[2]. Since the P distributed communication packets DP[p,2] (p=1, . . . , and P) are transmitted in order from the distributed processing node 3a[2], the reception unit 14a of the intermediate distributed processing node 3a[i] can finally acquire the M aggregated data R[m].

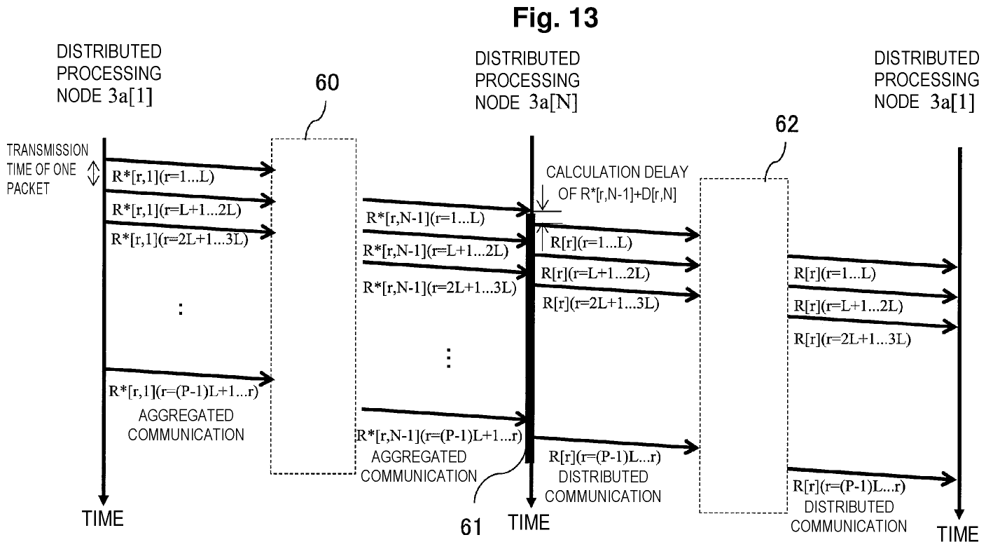

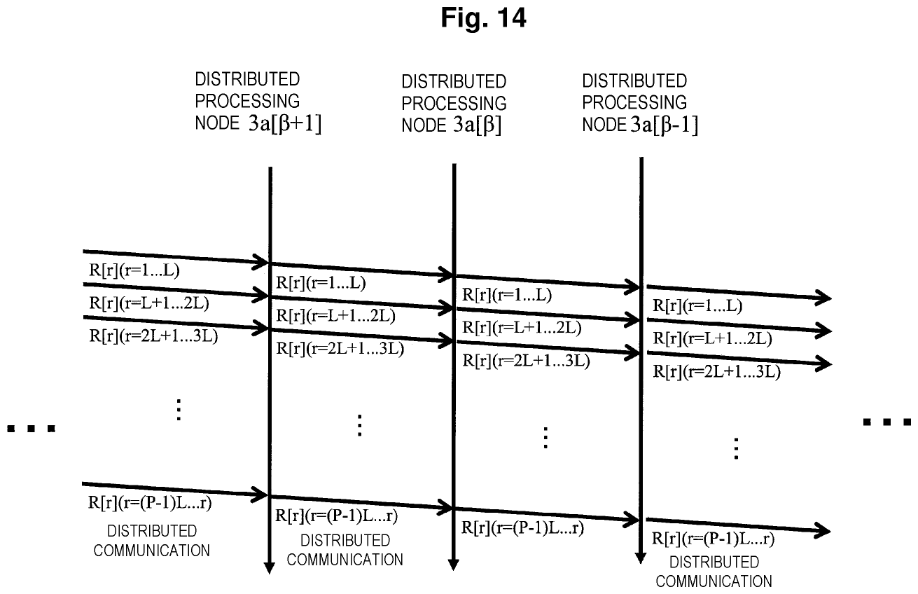

FIG. 13 and FIG. 14 show a sequence of processing of the distributed processing nodes 3a[n] (n=1, . . . , and N). Note that, since processing of a portion of 60 in FIG. 13 is the same as the processing shown in FIG. 6, description of the processing is omitted. The reference numeral 61 indicates the inter-node aggregation processing in the distributed processing node 3a[N]. FIG. 14 shows processing of a portion of 62 in FIG. 13, that is, distributed communication processing of distributed processing nodes 3a[β+1], 3a[β], and 3a[β−1] (β=N−2, . . . , and 3).

In this way, all of the aggregated communication from the distributed processing node 3a[j] 0=1, . . . , and N−1) to the distributed processing node 3a[j+1] (the processing for transmitting the intermediate aggregated data R*[m,j] to the distributed processing node 1[j+1]), the inter-node aggregation processing performed by the intermediate distributed processing node 3a[i] (i=2, . . . , and N−1) (the processing for calculating the intermediate aggregated data R*[m,i] based on the received intermediate aggregated data R*[m,i−1] and the distributed data D[m,i] generated by the own node), the inter-node aggregation processing performed by the distributed processing node 3a[N] (the processing for calculating the aggregated data R[m] based on the received intermediate aggregated data R*[m,N−1] and the distributed data D[m,N] generated by the own node), and the distributed communication from the distributed processing node 3a[j+1] to the distributed processing node 3a[j] (=1, . . . , and N−1) (the processing for distributing the aggregated data R[m] generated by the distributed processing node 3a[N] to the distributed processing node 3a[j]) are performed in the order of the numbers m of the weights w[m] and can be pipelined with the numbers m as units.

In this embodiment, as in the distributed processing system for deep learning explained in the first embodiment, the aggregated communication processing, the inter-node aggregation processing, and the distributed communication processing can be substantially simultaneously performed in parallel (in pipeline processing). Compared with related art in which the next processing cannot be started until each communication or each processing ends, it is possible to greatly reduce a processing time.

In particular, when a general communication path in which bit rates of the bidirectional communication path 4 connecting ring nodes are the same (a bit rate of the aggregated communication from the distributed processing node 3a[n] to a distributed processing node 3a[n+1] and a bit rate of the distributed communication from the distributed processing node 3a[n+1] to the distributed processing node 3a[n] are the same) is used and the inter-node aggregation processing is possible at the same rate, processing most efficiently using a band of the communication path is possible. This contributes to a reduction of a processing time.

It is possible to construct, on this system, the distributed processing system for deep learning explained in the first embodiment including the ring nodes equal to or less than K. Accordingly, it is possible to operate the system with an appropriate number of nodes according to a size of learning (the number of sample data and a calculation amount) without changing a physical configuration of the system (without increasing or reducing the number of ring nodes) (it is possible to stop the ring node not allocated to the distributed processing node 3a to operate as the relay node 3b). Therefore, it is possible to suppress wasteful consumption of electric power.

Note that, as it is evident from the above explanation, the configuration shown in FIG. 10 can function as the relay node 3b as well. When the ring node 3 functions as the relay node 3b, data received by the reception unit 14a is transmitted from the aggregated-data transmission unit 13a.

### Third Embodiment

A third embodiment of the present invention is explained. In this embodiment, concerning the distributed processing system for deep learning in the second embodiment, the operation of the distributed-processing control unit 5 for avoiding a failure that occurs in communication between distributed processing nodes (re-designation of the distributed processing nodes 3a[n] (n=1, . . . , and N) to the ring nodes) is explained.

Since the distributed processing system in this embodiment is the same as the distributed processing system shown in FIG. 7 and FIG. 9 in the second embodiment, the distributed processing system in this embodiment is explained using the reference numerals and signs in FIG. 7 and FIG. 9. That is, the distributed processing system in this embodiment includes the K (K is an integer equal to or larger than 3) ring nodes 3[k] (k=1, . . . , and K), the communication path 4[k] (k=1, . . . , and K) for the ring node 3[k] (k=1, . . . , and K) having the number k to bidirectionally communicate with the ring node 3[k+] having the next number k+(k+=k+1; in the case of k=K, k+=1), the distributed-processing control unit 5, and the network for control 6.

The distributed-processing control unit 5 is connected to the ring nodes 3[k] (k=1, . . . , and K) via the network for control 6. The distributed-processing control unit 5 designates, to the ring nodes 3[k] (k=1, . . . , and K), functions of the ring nodes as the distributed processing node 3a[n] (n=1, . . . , and N) or the relay node 3b via the network for control 6. However, in this designation, the ring node 3 designated as the distributed processing node 3a[j] 0=1, . . . , and N−1) need to be designated such that the ring node 3 is connected to the distributed processing nodes 3a[j+1] having preceding and following numbers via at least one of one or more communication paths 4 and one or more relay nodes 3b.

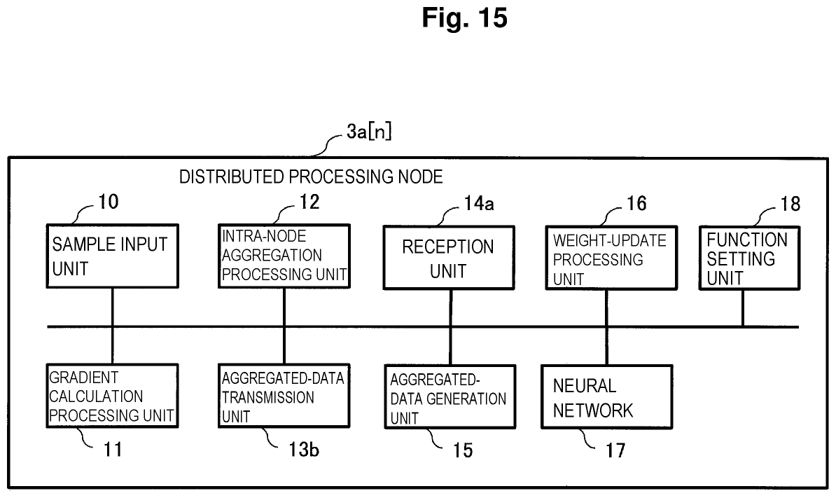

FIG. 15 is a block diagram showing a configuration example of the distributed processing nodes 3a[n] in this embodiment. Each of the distributed processing nodes 3a[n] includes the sample input unit 10, the gradient-calculation processing unit 11, the intra-node aggregation processing unit 12, an aggregated-data transmission unit 13b, the reception unit 14a, the aggregated-data generation unit 15, the weight-update processing unit 16, the neural network 17, and the function setting unit 18.

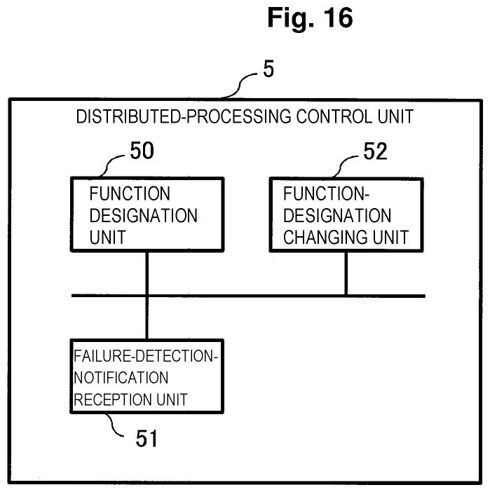

FIG. 16 is a block diagram showing a configuration example of the distributed-processing control unit 5. The distributed-processing control unit 5 includes a function designation unit 50 that designates the ring nodes 3[k] (k=1, . . . , and K) as the distributed processing node 3a[n] (n=1, . . . , and N) or the relay node 3b as in the first embodiment and this embodiment, a failure-detection-notification reception unit 51 that receives a failure detection notification from the distributed processing node 3a[n] (n=1, . . . , and N), and a function-designation changing unit 52 that changes the function designation of the ring nodes 3[k] (k=1, . . . , and K) when the failure detection notification is received.

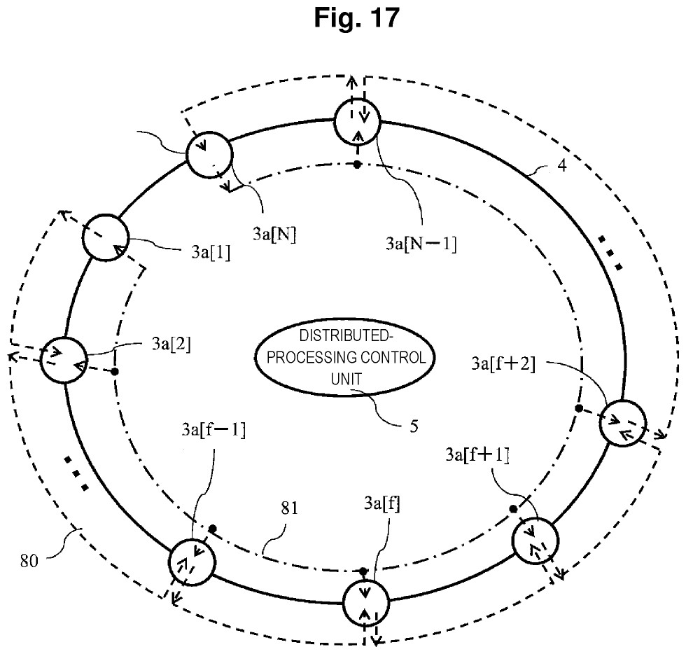

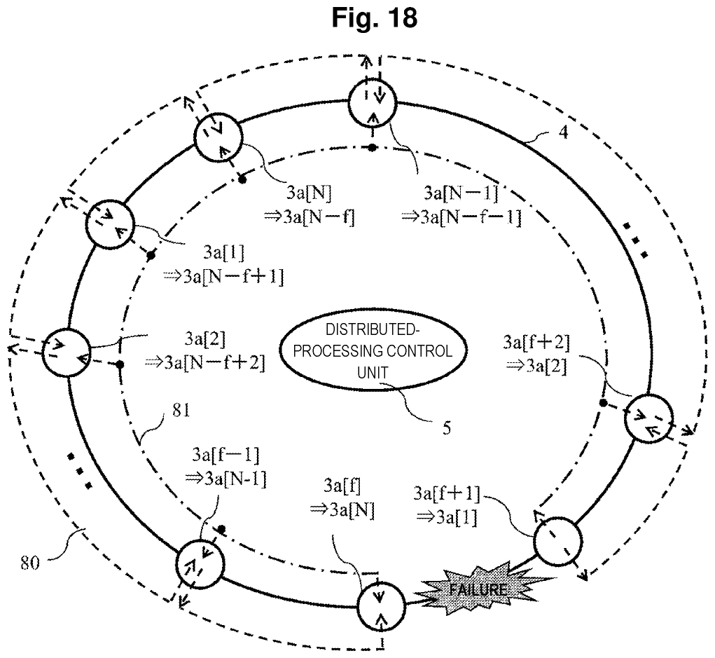

A state in which the ring nodes 3[k] (k=1, . . . , and K) are designated as the distributed processing node 3a[n] (n=1, . . . , and N) or the relay node 3b is shown in FIG. 17 and FIG. 18. Note that description of the relay node 3b and the network for control 6 is omitted in FIG. 17 and FIG. 18. The reference numeral 80 in FIG. 17 and FIG. 18 indicates a flow of aggregated communication. The reference numeral 81 in FIG. 17 and FIG. 18 indicates a flow of distributed communication. The functions of the distributed processing nodes 3a[n] (n=1, . . . , and N) and the relay node 3b are the same as the functions explained in the second embodiment.

The ring node 3 functioning as a distributed processing node 3a[f] (f=1, . . . , and N−1) generates distributed data D[m,f] as in the second embodiment. In the case of f=1, a first distributed processing node 3a[1] transmits distributed data D[m,1] generated by the own node to a distributed processing node 3a[2] having the next number as intermediate aggregated data R*[m,1]. In the case of f>1, an intermediate distributed processing node 3a[f] generates the intermediate aggregated data R*[m,f] from the distributed data D[m,f] generated by the own node and intermediate aggregated data R*[m,f−1] received from a distributed processing node 3a[f−1] and transmits the intermediate aggregated data R*[m,f] to a distributed processing node 3a[f+1] having the next number.

The ring node 3 functioning as a distributed processing node 3a[f+1] (f=2, . . . , N−1) generates distributed data D[m,f+1]. In the case of f<N−1, the distributed processing node 3a[f+1] generates intermediate aggregated data R*[m,f+1] from the distributed data D[m,f+1] generated by the own node and the intermediate aggregated data R*[m,f] received from the distributed processing node 3a[f] and transmits the intermediate aggregated data R*[m,f+1] to a distributed processing node 3a[f+2] having the next number.

In the case of f=N−1, the distributed processing node 3a[N] generates the aggregated data R[m] from the distributed data D[m,N] generated by the own node and the intermediate aggregated data R*[m,N−1] received from the distributed processing node 3a[N−1] and transmits the aggregated data R[m] to the distributed processing node 3a[N−1] having the preceding number. According to this distributed communication, all the distributed processing node 3a[n](n=1, . . . , and N) can acquire the same aggregated data R[m].

Thereafter, the distributed processing nodes 3a[n] (n=1, . . . , and N), which acquire the aggregated data R[m], perform, based on the aggregated data R[m], weight update processing for updating the weights w[m] of the neural network 17 in the own nodes.

According to an end of the weight update processing, one minibatch learning ends. The distributed processing nodes 3a[n] (n=1, . . . , and N) continuously perform processing of the next minibatch learning based on the updated weights. That is, the distributed processing nodes 3a[n] receive sample data for the next minibatch learning from a not-shown data collection node and repeat the processing of the minibatch learning explained above to thereby improve inference accuracy of the neural network 17.

The aggregated-data transmission unit 13b of the distributed processing node 3a[n](n=1, . . . , and N) has a failure detection function for detecting a failure to transfer the intermediate aggregated data R* or the aggregated data R between the distributed processing node 3a[n] and the ring node 3 functioning as an adjacent distributed processing node 3a (the distributed processing node 3a having the preceding number or the next number). The aggregated-data transmission unit 13b has a function of, when detecting a failure, notifying the failure detection to the distributed-processing control unit 5 via the network for control 6.

The failure-detection-notification reception unit 51 of the distributed-processing control unit 5 receives the notification of the failure detection from the aggregated-data transmission unit 13b of the distributed processing node 3a[n]. When receiving the notification of the failure detection, the function-designation changing unit 52 of the distributed-processing control unit 5 avoids the failure by changing the function designation of the ring nodes 3[k](k=1, . . . , and K) (changing the designation of the distributed processing node 3a[n]).

After the change of the function designation of the ring nodes 3[k] (k=1, . . . , and K), the distributed processing system performs reprocessing of the aggregated communication processing, the inter-node aggregation processing, and the distributed communication processing suspended by the failure and continues the aggregated communication processing, the inter-node aggregation processing, and the distributed communication processing thereafter.

FIG. 17 shows a state in which the ring nodes 3 are designated as the distributed processing node 3a[n] (n=1, . . . , and N) or the relay node 3b by the distributed-processing control unit 5. A system equivalent to the distributed processing system explained in the first embodiment is constructed. In FIG. 17, a failure does not occur and normal processing is continuously performed.

When detecting a failure to transfer the intermediate aggregated data R*[m,f] from the distributed processing node 3a[f] (f=1, . . . , and N−1) to the distributed processing node 3a[f+1] or transfer the aggregated data R[m] from the distributed processing node 3a[f+1] to the distributed processing node 3a[f], the aggregated-data transmission unit 13b of at least one of the distributed processing node 3a[f] and the distributed processing node 3a[f+1] notifies the failure detection to the distributed-processing control unit 5.

Note that the failure includes not only a complete failure of transfer but also a failure of frequent occurrence of processing such as resending because of a high error rate with respect to data being transferred and difficulty in normal system operation (the error rate exceeding a threshold).

Rather than detecting a failure to transfer data between distributed processing nodes, it is also possible to detect signal interruption or error rate deterioration between any ring nodes connected via a communication path and treat the signal interruption or the error rate deterioration as a failure between distributed processing nodes communicating via the communication path between the ring nodes. That is, when the ring node 3 functions as the relay node 3b, the aggregated-data transmission unit 13b of the relay node 3b can notify failure detection to the distributed-processing control unit 5 when the intermediate aggregated data R* or the aggregated data R cannot be transferred to the adjacent ring node 3 present in a direction in which the intermediate aggregated data R* or the aggregated data R should be transferred (or when the error rate exceeds the threshold).

The function-designation changing unit 52 of the distributed-processing control unit 5, which receives the notification of the failure detection, changes the function designation of the ring nodes 3[k] (k=1, . . . , and K) to change the distributed processing system to a system configured from a distributed processing node 3a[n′] (n′=1, . . . , and N−1) that does not use the communication path 4 between the distributed processing node 3a[f] in which the failure occurs and the distributed processing node 3a[f+1] and the relay node 3b, that is, a distributed processing system equivalent to the distributed processing system before the detection of the failure. This change causes the ring nodes 3 functioning as the distributed processing node 3a[n](n=1, . . . , and N) to function as the distributed processing node 3a[n′] (n′=n−f; in the case of n−f<1, n′=n−f+N).

FIG. 18 shows a state in which, after a failure is detected, the ring nodes 3 are designated as the distributed processing node 3a[n′] (n′=1, . . . , and N) or the relay node 3b by the distributed-processing control unit 5. Like the system before the detection of the failure, the distributed processing system is a system equivalent to the distributed processing system explained in the first embodiment.

The ring node 3, which is the distributed processing node 3a[f] before the detection of the failure, is changed to the distributed processing node 3a[N]. The ring node 3, which is the distributed processing node 3a[f+1] before the detection of the failure, is changed to the distributed processing node 3a[1]. The ring node 3 designated as the distributed processing node 3a[n′] (n=1, . . . , and N−1) is changed to be connected to a distributed processing node 3a[n′+1] via one or more communication paths 4 or via one or more communication paths 4 and one or more relay nodes 3b.

In this way, in this embodiment, when the failure to transfer the intermediate aggregated data R* and the aggregated data R between the distributed processing node 3a and the adjacent distributed processing node 3a occurs, it is possible to change the distributed processing system to the distributed processing system equivalent to the distributed processing system before the failure while avoiding the failure. Therefore, it is possible to provide a system robust against the failure.

### Fourth Embodiment

A fourth embodiment of the present invention is explained. The distributed processing system for deep learning in the second embodiment, the third embodiment, and this embodiment is a ring system and includes the K (K is an integer equal to or larger than 3) ring nodes 3[k] (k=1, . . . , and K), the communication path 4[k] (k=1, . . . , and K) for the ring node 3[k](k=1, . . . , and K) having the number k to bidirectionally communicate with the ring node 3[k+] having the next number k+ (k+=k+1, in the case of k=K, k+=1), the distributed-processing control unit 5, and the network for control 6. The distributed-processing control unit 5 is connected to the ring nodes 3[k] (k=1, . . . , and K) via the network for control 6.

In the second embodiment and the third embodiment, the example is explained in which the distributed processing system explained in the first embodiment is constructed on the ring system. In this embodiment, an example is explained in which different two distributed processing systems are constructed on one ring system.

Note that it is also possible to construct three or more distributed processing systems on one ring system. However, a function requirement for the ring nodes is the same. To simplify explanation, in the following explanation, two distributed processing systems (a group A and a group B) are constructed.

The distributed-processing control unit 5 designates, via the network for control 6, the ring nodes 3[k] (k=1, . . . , and K) as one of Na distributed processing nodes 3aA[γ] (γ=1, . . . , and Na) belonging to the group A, one of Nb distributed processing nodes 3aB[δ](δ=1, . . . , and Nb) belonging to the group B, or the relay node 3b. The number of nodes K of the ring node 3 needs to be equal to or larger than a sum of the numbers of distributed processing nodes belonging to groups that can simultaneously present in a ring system. In this embodiment, K≥Na+Nb is a necessary requirement (Na and Nb are respectively integers equal to or larger than 2 and a sum of Na and Nb is equal to or smaller than K).

The ring node 3 designated as the distributed processing node 3aA[γ] (γ=1, . . . , and Na−1) belonging to the group A needs to be designated to be connected to distributed processing nodes 3a[γ+1] having preceding and following numbers belonging to the same group A via at least one of one or more communication paths 4, one or more relay nodes 3b, and one or more distributed processing nodes 3aB[δ] of the other group (the group B).

Similarly, the ring node 3 designated as the distributed processing node 3aB[δ] (δ=1, . . . , and Nb−1) belonging to the group B needs to be designated to be connected to distributed processing nodes 3a[δ+1] having preceding and following numbers belonging to the same group B via at least one of one or more communication paths 4, one or more relay nodes 3b, and one or more distributed processing nodes 3aA[γ] of the other group (the group A).

The same holds true when the number of groups is three or more. The distributed processing nodes 3a belonging to each of the group needs to be designated to be connected to the distributed processing nodes 3a having preceding and following numbers belonging to the same group via at least one of one or more communication paths 4, one or more relay nodes 3b, and one or more distributed processing nodes 3a of the other groups.

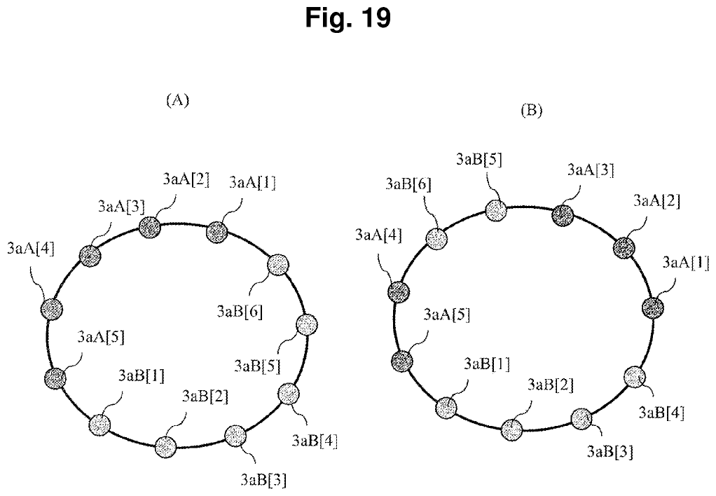

FIG. 19(A) and FIG. 19(B) show a state in which the ring nodes 3[k] (k=1, . . . , and K) are designated as Na (Na=5) distributed processing nodes 3aA[γ] (γ=1, . . . , and Na) belonging to the group A, Nb (Nb=6) distributed processing nodes 3aB[δ](δ=1, . . . , and Nb) belonging to the group B, or the relay node 3b. Note that, in FIG. 19(A) and FIG. 19(B), description of the relay node 3b, the distributed-processing control unit 5, and the network for control 6 is omitted.

FIG. 19(A) shows a configuration without a section where a path between distributed processing nodes belonging to the same group and a path between distributed processing nodes belonging to another group overlap. FIG. 19(B) shows a configuration with a section where a path between distributed processing nodes belonging to the same group and a path between distributed processing nodes belonging to another group overlap. In both the configurations, the ring nodes 3 functioning as the distributed processing nodes perform processing explained below, whereby the two groups of the configurations can respectively operate as the distributed processing systems in the first embodiment independent from each other.

Note that the ring nodes 3 functioning as the relay node 3b only have to perform the same processing as the processing explained in the second embodiment. The ring nodes 3 only have to transfer the intermediate aggregated data R* or the aggregated data R received from the adjacent ring node 3 connected via the communication path 4 to the ring node 3 present in a direction in which the data should be transferred. This transfer processing does not depend on a group of the distributed processing nodes that transmit and receive the intermediate aggregated data R* or the aggregated data R.

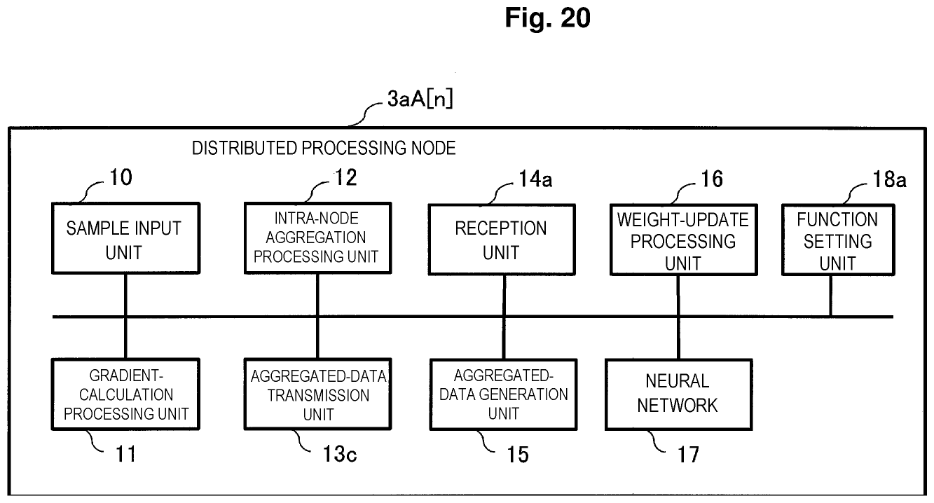

FIG. 20 is block diagram showing a configuration example of the distributed processing nodes 3aA[γ] belonging to the group A. The same components as the components shown in FIG. 2 and FIG. 10 are denoted by the same reference numerals and signs. Each of the distributed processing nodes 3aA[γ] includes the sample input unit 10, the gradient-calculation processing unit 11, the intra-node aggregation processing unit 12, an aggregated-data transmission unit 13c, the reception unit 14a, the aggregated-data generation unit 15, the weight-update processing unit 16, the neural network 17, and a function setting unit 18a.

The function setting unit 18a in this embodiment receives, from the distributed-processing control unit 5, addresses of all the distributed processing nodes 3a including addresses of the distributed processing nodes 3a having preceding and following numbers of the own distributed processing node and receives a group identifier of the own distributed processing node from the distributed-processing control unit 5.

The configuration of the distributed processing node 3aB[δ] belonging to the group B is the same as the configuration of the distributed processing node 3aA[γ].

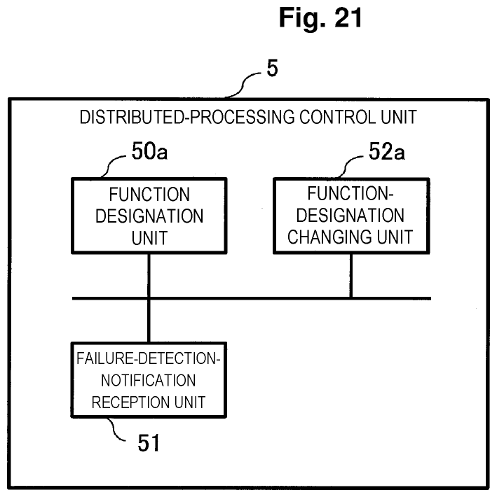

FIG. 21 is a block diagram showing a configuration example of the distributed-processing control unit 5 in this embodiment. The distributed-processing control unit 5 in this embodiment includes a function designation unit 50a, the failure-detection-notification reception unit 51, and a function-designation changing unit 52a.

When designating the ring nodes 3[k] (k=1, . . . , and K) as the distributed processing node 3aA[γ] or 3aB[δ] or the relay node 3b as in the second and third embodiments, the function designation unit 50a notifies addresses of all the distributed processing nodes 3aA[γ] or 3aB[δ] to the distributed processing nodes 3aA[γ] or 3aB[δ] and notifies a group identifier to the distributed processing nodes 3aA[γ] or 3aB[δ].

When changing the function designation of the ring nodes 3[k] (k=1, . . . , and K) as in the third embodiment, the function-designation changing unit 52 notifies addresses of all the distributed processing nodes 3aA[γ] or 3aB[δ] after the change to the distributed processing nodes 3aA[γ] or 3aB[δ] after the change and notifies a group identifier after the change to the distributed processing nodes 3aA[γ] or 3aB[δ].

The intra-node aggregation processing unit 12 of the ring node 3[h] functioning as a first distributed processing node 3aA[1] or 3aB[1] belonging to the group A or B generates the distributed data D[m,f] as in the first to third embodiments.

The aggregated-data transmission unit 13c of the distributed processing node 3aA[1] or 3aB[1] transmits, as intermediate aggregated data R*[m,1], the distributed data D[m,1] generated by the own node to a ring node 3[h+] (h+=h+1; in the case of h=K, h+=1) having the next number via a communication path 4[h]. That is, the aggregated-data transmission unit 13c transmits the intermediate aggregated data R*[m,1] to a distributed processing node 3aA[2] or 3aB[2] having the next number belonging to the same group.

The ring node 3[t] functioning as the relay node 3b transfers, to the ring node 3[t+] having the following number t+ (t+=t+1; in the case of t=K, t+=1), via the communication path 4[t], the intermediate aggregated data R* received from the ring node 3[t−] having the preceding number t− (t−=t−1; in the case of t=1, t−=K) via the communication path 4[t−]. The ring node 3[u] functioning as the relay node 3b is the same as the ring node 3[t].

The intra-node aggregation processing unit 12 of the ring node 3[z] functioning as an intermediate distributed processing node 3aA[i] or 3aB[i] (i=2, . . . , and N−1) belonging to the group A or B generates the distributed data D[m,i] (m=1, . . . , and M) as in the first to third embodiments.

The reception unit 14a of the intermediate distributed processing node 3aA[i] or 3aB[i] receives the intermediate aggregated data R*[m,i−1] generated and transmitted by a distributed processing node 3aA[i−1] or 3aB[i−1] belonging to the same group from the ring node 3[z−] having the preceding number z− (z−=z−1; in the case of z=1, z−=K) via the communication path 4[z−].

The aggregated-data generation unit 15 of the intermediate distributed processing node 3aA[i] or 3aB[i] calculates, for each of the weights w[m] corresponding thereto, a sum of the received intermediate aggregated data R*[m,i−1] and the distributed data D[m,i] generated by the own node to thereby generate the intermediate aggregated data R*[m,i].

The aggregated-data transmission unit 13c of the intermediate distributed processing node 3aA[i] or 3aB[i] transmits the intermediate aggregated data R*[m,i] generated by the own node to the ring node 3[z+] having the next number z+ (z+=z+1; in the case of z=K, z+=1) via the communication path 4[z]. That is, the aggregated-data transmission unit 13c transmits the intermediate aggregated data R*[m,i] to a distributed processing node 3aA[i+1] or 3aB[i+1] having the next number belonging to the same group.

The intra-node aggregation processing unit 12 of a ring node 3[e] functioning as a last distributed processing node 3aA[N] or 3aB[N] belonging to the group A or B generates the distributed data D[m,N] (m=1, . . . , and M) as in the first to third embodiments.

The reception unit 14a of the last distributed processing node 3aA[N] or 3aB[N] receives the intermediate aggregated data R*[m,N−1] transmitted and generated by a distributed processing node 3aA[N−1] or 3aB[N−1] belonging to the same group from the ring node 3[e−] having the preceding number e− (e−=e−1; in the case of e=1, e−=K) via the communication path 4[e−].

The aggregated-data generation unit 15 of the last distributed processing node 3aA[N] or 3aB[N] calculates, for each of the weights w[m] corresponding thereto, a sum of the received intermediate aggregated data R*[m,N−1] and the distributed data D[m,N] generated by the own node to thereby generate the aggregated data R[m].

The aggregated-data transmission unit 13c of the last distributed processing node 3aA[N] or 3aB[N] transmits the aggregated data R[m] generated by the own node to the ring node 3[e−] having the preceding number e−. That is, the aggregated-data transmission unit 13c transmits the aggregated data R[m] to the distributed processing node 3aA[N−1] or 3aB[N−1] having the preceding number belonging to the same group. The operation of the weight-update processing unit 16 of the last distributed processing node 3aA[N] or 3aB[N] is the same as the operation in the first embodiment.

The reception unit 14a of the ring node 3[z] functioning as the intermediate distributed processing node 3aA[i] or 3aB[i] (i=2, . . . , and N−1) belonging to the group A or B receives, from the ring node 3[z+] having the following number z+ (z+=z+1; in the case of z=K, z+=1), via the communication path 4[z+], the aggregated data R[m] transmitted by the distributed processing node 3aA[i+1] or 3aB[i+1] belonging to the same group.

The aggregated-data transmission unit 13c of the intermediate distributed processing node 3aA[i] or 3aB[i] transmits the aggregated data R[m] to the ring node 3[z−] having the preceding number z− (z−=z−1; in the case of z=1, z−=K) via the communication path 4[z−]. That is, the aggregated-data transmission unit 13c transmits the aggregated data R[m] to the distributed processing node 3a [i−1] having the preceding number belonging to the same group. The operation of the weight-update processing unit 16 of the intermediate distributed processing node 3aA[i] or 3aB[i] is the same as the operation in the first embodiment.

The reception unit 14a of the ring node 3[h] functioning as the first distributed processing node 3aA[1] or 3aB[1] belonging to the group A or B receives, from the ring node 3[h+] having the following number h+ (h+=h+1; in the case of h=K, h+=1), via the communication path 4[h+], the aggregated data R[m] transmitted by the distributed processing node 3aA[2] or 3aB[2] belonging to the same group. The operation of the weight-update processing unit 16 of the first distributed processing node 3aA[1] or 3aB[1] is the same as the operation in the first embodiment.

According to an end of the weight update processing, one minibatch learning ends. The distributed processing nodes 3aA[γ] (γ=1, . . . , and Na), 3aB[δ](δ=1, . . . , and Nb) continuously perform processing of the next minibatch learning based on the updated weights. That is, the distributed processing nodes 3aA[γ] or 3aB[δ] receive sample data for the next minibatch learning from a not-shown data collection node and repeat the processing of the minibatch learning explained above to thereby improve inference accuracy of the neural network 17.

The processing explained above is processing in the case in which the distributed processing node 3aA[γ] or 3aB[δ] belonging to the group A or B receives data generated by the distributed processing node belonging to the same group. The processing is the same as the processing of the distributed processing node explained in the second embodiment.

On the other hand, the distributed processing node that receives the intermediate aggregated data R* or the aggregated data R generated by the distributed processing node belonging to another group functions as the relay node 3b for the intermediate aggregated data R* or the aggregated data R.

Specifically, the ring node 3[t] functioning as the distributed processing node 3aA[γ] or 3aB[δ] belonging to a certain group transfers, to the ring node 3[t+] having the following number t+ (t+=t+1; in the case of t=K, t+=1), via the communication path 4[t], the intermediate aggregated data R* generated by the distributed processing node of another group received from the ring node 3[t−] having the preceding number t− (t−=t−1; in the case of t=1, t−=K) via the communication path 4[t−]. The ring node 3[t] transfers, to the ring node 3[t−] having the preceding number t− (t−=t−1; in the case of t=1, t−=K), via the communication path 4[t−], the aggregated data R transmitted from the distributed processing node of another group received from the ring node 3[t+] having the following number t+ (t+=t+1; in the case of t=K, t+=1) via the communication path 4[t+]. In this way, when receiving, from the adjacent ring node 3, the data generated and transmitted by the distributed processing node not belonging to the own node, the distributed processing node 3aA[γ] or 3aB[δ] directly sends the data to the other adjacent ring node 3.

In the second embodiment, the distributed processing system performs the aggregated communication for allocating the intermediate aggregated data R*[m,n] (m=1, . . . , and M) generated by the distributed processing nodes 3a[n] (n=1, . . . , and N−1) to the P aggregated communication packets by L intermediate aggregated data R*[m,n] at a time in the order of the numbers m of the weights w[m] and transmitting the P aggregated communication packets in order until finishing transmitting all the aggregated communication packets. The distributed processing system performs distributed communication for allocating the aggregated data R[m] (m=1, . . . , and M) generated by the distributed processing nodes 3a[n] to the P distributed communication packets by L intermediate aggregated data R[m] at a time in the order of the numbers m and transmitting the P distributed communication packets in order until finishing transmitting all the distributed communication packets.

In this embodiment, as in the second embodiment, the ring node 3 functioning as the distributed processing node 3aA[γ] or 3aB[δ] packetizes and transmits and receives data. The aggregated-data transmission unit 13c of the ring node 3 gives, to the aggregated communication packets and the distributed communication packets, a group identifier indicating to which group the own node belongs (to which group the packet belongs). As explained above, the group identifier is notified from the distributed-processing control unit 5.

Further, the aggregated-data transmission unit 13c of the ring node 3 functioning as the distributed processing node 3aA[γ] or 3aB[δ] determines, based on the group identifier given to the aggregated communication packet or the distributed communication packet received by the reception unit 14a, whether the aggregated communication packet or the distributed communication packet is a packet generated and transmitted by the distributed processing node belonging to the same group (a packet belonging to the own group).

If the received aggregated communication packet or distributed communication packet is the packet of the own group, the aggregated-data transmission unit 13c of the ring node 3 functioning as the distributed processing node 3aA[γ] or 3aB[δ] processes data (the intermediate aggregated data R* or the aggregated data R) acquired from the packet as data generated and transmitted by the distributed processing node belonging to the same group as in the second and third embodiments. If the received aggregated communication packet or distributed communication packet is not the packet of the own group, the aggregated-data transmission unit 13c sends the data (the intermediate aggregated data R* or the aggregated data R) acquired from the packet to the adjacent ring node 3 present in a direction in which the data should be transferred.

Note that the group identifier only has to be arranged in a decided position in the aggregated communication packet or the distributed communication packet. If a packet conforms to a format of the Ethernet (registered trademark), implementation for, for example, giving a VLAN tag (a VLAN-ID) to a destination MAC (Media Access Control) address or a part of the destination MAC address and setting the VLAN tag as a group identifier is possible.

In this embodiment, a physical ring system configured by K (K is an integer equal to or larger than 3) ring nodes can be configured as a system that simultaneously performs a plurality of deep learnings. In this embodiment, under a condition that a total number of distributed processing nodes is equal to or smaller than the number of ring nodes, in the deep learnings, an appropriate number of distributed processing nodes can be decided according to sizes (the numbers of sample data and calculation amounts) of the learnings. Therefore, since ring nodes not entirely used in one deep learning can be allocated to the other deep learnings, it is possible to efficiently operate the system (at a high operation ratio of the ring nodes).

Note that, in this embodiment, the example is explained in which a plurality of distributed processing systems are constructed on one ring system in the second embodiment. However, it goes without saying that a plurality of distributed processing systems may be constructed on one ring system in the third embodiment.

Each of the distributed processing node 1, the ring node 3 (the distributed processing node 3a and the relay node 3b), and the distributed-processing control unit 5 explained in the first to fourth embodiments can be realized by a computer including a CPU (Central Processing Unit), a storage device, and an interface and a program for controlling these hardware resources. The CPU of each of the distributed processing node 1, the ring node 3, and the distributed-processing control unit 5 executes the processing explained in the first to fourth embodiments according to the program stored in the storage device of each of the distributed processing node 1, the ring node 3, and the distributed-processing control unit 5.

### INDUSTRIAL APPLICABILITY

Embodiments of the present invention can be applied to a technique for performing machine learning of a neural network.

### REFERENCE SIGNS LIST

1, 3a Distributed processing node
2 Network for distributed processing
3 Ring node
3b Relay node
4 Communication path
5 Distributed-processing control unit
6 Network for control
10 Sample input unit
11 Gradient-calculation processing unit
12 Intra-node aggregation processing unit
13, 13a, 13b, 13c Aggregated-data transmission unit
14, 14a Reception unit
15 Aggregated-data generation unit
16 Weight-update processing unit
17 Neural network
18, 18a Function setting unit
50, 50a Function designation unit
51 Failure-detection-notification reception unit
52, 52a Function-designation changing unit

1.-8. (canceled)

9. A distributed processing system comprising:
N distributed processing nodes connected to one another via a network, wherein N is an integer equal to or larger than 2, and wherein:
the N distributed processing nodes are configured to generate distributed data for each of M weights w[m] (m=1, . . . , and M) of a learning target neural network, wherein M is an integer equal to or larger than 2,
among the N distributed processing nodes, a predetermined first distributed processing node is configured to set, as first aggregated data, first distributed data generated by itself, packetize the first aggregated data in order of numbers m of the weights w[m], and transmit the first aggregated data to a second distributed processing node having a next number designated in advance,
among the N distributed processing nodes, each of one or more intermediate distributed processing nodes excluding the first distributed processing node and a predetermined last distributed processing node is configured to calculate, for each of the weights w[m] corresponding thereto, a sum of the received first aggregated data and second distributed data generated by itself, generate updated first aggregated data after an update, packetize the updated first aggregated data in the order of the numbers m, and transmit the updated first aggregated data to a following distributed processing node having a next number designated in advance,
among the N distributed processing nodes, the predetermined last distributed processing node is configured to calculate, for each of the weights w[m] corresponding thereto, a sum of the received updated first aggregated data and third distributed data generated by itself, generate second aggregated data, packetize the second aggregated data in the order of the numbers m, and transmit the second aggregated data to the first and the one or more intermediate distributed processing nodes, and
the N distributed processing nodes are configured to update the weights w[m] of the learning target neural network based on the second aggregated data.

10. The distributed processing system according to claim 9, wherein each of the distributed processing nodes includes:
an aggregated-data transmitter that, when the distributed processing node is the first distributed processing node, is configured to packetize the first aggregated data in the order of the numbers m and transmit the first aggregated data to the second distributed processing node having the next number designated in advance, when the distributed processing node is one of the one or more intermediate distributed processing nodes, is configured to packetize the updated first aggregated data in the order of the numbers m and transmit the updated first aggregated data to the following distributed processing node having the next number designated in advance, and, when the distributed processing node is the last distributed processing node, is configured to packetize the second aggregated data in the order of the numbers m and transmit the second aggregated data to the first and the one or more intermediate distributed processing nodes;
an aggregated-data generator that, when the distributed processing node is one of the intermediate distributed processing nodes, is configured to generate the updated first aggregated data and, when the distributed processing node is the last distributed processing node, is configured to generate the second aggregated data;
a receiver that, when the distributed processing node is the first or one of the intermediate distributed processing nodes, is configured to receive the first aggregated data and the second aggregated data and, when the distributed processing node is the last distributed processing node, is configured to receive the first aggregated data; and
a weight-update processor configured to update the weights w[m] of the learning target neural network based on the second aggregated data.

11. A distributed processing system comprising:
K ring nodes in a ring shape and connected to one another by adjacent ring nodes via a communication path, wherein K is an integer equal to or larger than 3; and
a distributed-processing controller configured to designate each of the K ring nodes as a distributed processing node or a relay node, wherein:
among the K ring nodes, N ring nodes configured to function as N distributed processing nodes are configured to generate distributed data for each of M weights w[m] (m=1, . . . , and M) of a learning target neural network, wherein N is an integer equal to or larger than 2 and equal to or smaller than K, and wherein M is an integer equal to or larger than 2,
a first ring node configured to function as a first distributed processing node designated in advance among the N distributed processing nodes is configured to set, as first aggregated data, first distributed data generated by itself, packetize the first aggregated data in order of numbers m of the weights w[m], and transmit the first aggregated data to a second distributed processing node having a next number designated in advance,
a second ring node configured to function as an intermediate distributed processing node excluding the first distributed processing node and a last distributed processing node among the N distributed processing nodes is configured to calculate, for each of the weights w[m] corresponding thereto, a sum of the received first aggregated data and second distributed data generated by itself, generate updated first aggregated data after an update, packetize the updated first aggregated data in the order of the numbers m, and transmit the updated first aggregated data to a following distributed processing node having a next number designated in advance,
a third ring node configured to function as the last distributed processing node designated in advance among the N distributed processing nodes is configured to calculate, for each of the weights w[m] corresponding thereto, a sum of the received updated first aggregated data and third distributed data generated by itself, generate second aggregated data, packetize the second aggregated data in the order of the numbers m, and transmit the second aggregated data to a distributed processing node having a preceding number designated in advance,
the second ring node is configured to packetize the received second aggregated data in the order of the numbers m and transmit the second aggregated data to a preceding distributed processing node having a preceding number designated in advance,
among the K ring nodes, the ring nodes configured to function as the relay nodes are configured to transmit the received updated first aggregated data or the received second aggregated data to a distributed processing node at a transfer destination, and
the N distributed processing nodes are configured to update the weights w[m] of the learning target neural network based on the second aggregated data.

12. The distributed processing system according to claim 11, wherein each of the ring nodes includes:
an aggregated-data transmitter that, when the ring node is configured to function as the first distributed processing node, is configured to packetize the first aggregated data in the order of the numbers m and transmit the first aggregated data to the second distributed processing node having the next number designated in advance, when the ring node is configured to function as the intermediate distributed processing node, is configured to packetize the updated first aggregated data in the order of the numbers m and transmit the updated first aggregated data to the following distributed processing node having the next number designated in advance, when the ring node is configured to function as the last distributed processing node, is configured to packetize the second aggregated data in the order of the numbers m and transmit the second aggregated data to the distributed processing node having the preceding number designated in advance, and, when the ring node is configured to function as the relay node, is configured to transmit the received first aggregated data or the received second aggregated data to the distributed processing node at the transfer destination;
an aggregated-data generator that, when the ring node is configured to function as the intermediate distributed processing node, is configured to generate the updated first aggregated data and, when the ring node is configured to function as the last distributed processing node, is configured to generate the second aggregated data;
a receiver that, when the ring node is configured to function as the first or the intermediate distributed processing node, is configured to receive the first aggregated data and the second aggregated data and, when the ring node is configured to function as the last distributed processing node, is configured to receive the first aggregated data; and
a weight-update processor configured to update the weights w[m] of the learning target neural network based on the second aggregated data when the ring node is configured to function as the distributed processing node.

13. The distributed processing system according to claim 11, wherein the distributed-processing controller includes:
a function designator configured to designate each of the K ring nodes as the distributed processing node or the relay node; and
a function-designation changer that, when a failure to transmit the first aggregated data or the second aggregated data to the distributed processing node at the transfer designation occurs, is configured to change a function designation of the ring nodes to avoid the failure.

14. The distributed processing system according to claim 11, wherein the distributed-processing controller is configured to designate each of the K ring nodes designated as the distributed processing node to belong to any one group among a plurality of different groups.

15. The distributed processing system according to claim 14, wherein:
the first ring node configured to function as the first distributed processing node designated in advance among the N distributed processing nodes is configured to set, as first aggregated data, the first distributed data generated by itself, packetize the first aggregated data in order of the numbers m of the weights w[m], and transmit the first aggregated data to the second distributed processing node having the next number designated in advance belonging to a same group,
the second ring node functioning as the intermediate distributed processing node excluding the first distributed processing node and the last distributed processing node among the N distributed processing nodes is configured to calculate, for each of the weights w[m] corresponding thereto, the sum of the first aggregated data transmitted from the first distributed processing node of the same group and the second distributed data generated by itself, generate the updated first aggregated data, packetize the updated first aggregated data in the order of the numbers m, and transmit the updated first aggregated data to the following distributed processing node having the next number designated in advance belonging to the same group,
the third ring node configured to function as the predetermined last distributed processing node among the N distributed processing nodes is configured to calculate, for each of the weights w[m] corresponding thereto, the sum of the first aggregated data transmitted from the first distributed processing node of the same group and third distributed data generated by itself, generate the second aggregated data, packetize the second aggregated data in the order of the numbers m, and transmit the second aggregated data to the distributed processing node having the preceding number designated in advance belonging to the same group,
the second ring node configured to function as the intermediate distributed processing node among the N distributed processing nodes is configured to packetize the second aggregated data transmitted from the third distributed processing node of the same group in the order of the numbers m, and transmit the second aggregated data to the next distributed processing node having the preceding number designated in advance belonging to the same group, and
the distributed processing nodes are configured to update the weights w[m] of the learning target neural network based on the second aggregated data generated and transmitted in the distributed processing node of the same group.

16. A distributed processing method comprising:
a first step in which each of N distributed processing nodes connected to one another via a network generates distributed data for each of M weights w[m] (m=1, . . . , and M) of a learning target neural network, wherein N is an integer equal to or larger than 2 and M is an integer equal to or larger than 2;
a second step in which, among the N distributed processing nodes, a predetermined first distributed processing node sets, as first aggregated data, first distributed data generated by itself, packetizes the first aggregated data in order of numbers m of the weights w[m], and transmits the first aggregated data to a second distributed processing node having a next number designated in advance;
a third step in which, among the N distributed processing nodes, each of one or more intermediate distributed processing nodes excluding the first distributed processing node and a predetermined last distributed processing node calculates, for each of the weights w[m] corresponding thereto, a sum of the received first aggregated data and second distributed data generated by itself, generates updated first aggregated data after an update, packetizes the updated first aggregated data in the order of the numbers m, and transmits the updated first aggregated data to a following distributed processing node having a next number designated in advance;
a fourth step in which, among the N distributed processing nodes, the predetermined last distributed processing node calculates, for each of the weights w[m] corresponding thereto, a sum of the received updated first aggregated data and third distributed data generated by itself, generates second aggregated data, packetizes the second aggregated data in the order of the numbers m, and transmits the second aggregated data to the first and the one or more intermediate distributed processing nodes; and
a fifth step in which the N distributed processing nodes update the weights w[m] of the learning target neural network based on the second aggregated data.
